(19) United States
(12) Patent Application Publication
(10) Pub. No.: US 2025/0097382 A1
(43) Pub. Date: Mar. 20, 2025

(54) NON-TRANSITORY RECORDING MEDIUM, IMAGE PROCESSING SYSTEM, TELECONFERENCE SERVICE SYSTEM

(71) Applicants: Ryutarou ONO, Tokyo (JP); Yuichi KAWASAKI, Tokyo (JP)

(72) Inventors: Ryutarou ONO, Tokyo (JP); Yuichi KAWASAKI, Tokyo (JP)

(21) Appl. No.: 18/882,809

(22) Filed: Sep. 12, 2024

(30) Foreign Application Priority Data
Sep. 15, 2023 (JP) 2023-150434

(51) Int. Cl. H04N 7/15

(52) U.S. Cl. CPC H04N 7/15

(57) ABSTRACT

A non-transitory recording medium that stores a plurality of program codes. When the program code is executed by one or more processors, there is a calculating of a scale ratio of each image transmitted from each site so that a subject size in each image is approximately the same. Furthermore, there is a displaying of each image that has been scaled by a teleconference service system at the scale ratio at a terminal at each site.

### CROSS-REFERENCE TO RELATED APPLICATION

This patent application is based on and claims priority pursuant to 35 U.S.C. § 119(a) to Japanese Patent Application No. 2023-150434, filed on Sep. 15, 2023, in the Japan Patent Office, the entire disclosure of which is hereby incorporated by reference herein.

### BACKGROUND

### Technical Field

Embodiments of this disclosure relate to non-transitory recording medium, an image processing system, and a teleconference service system.

### Related Art

A telecommunication system is known that transmits images and audio from one location to one or more other locations in real time, and allows users in remote locations to hold conferences using images and audio.

In the telecommunication, one location communicates with multiple locations, and images from multiple locations are displayed simultaneously on terminal devices such as PCs.

A technique to simultaneously display multiple images transmitted from each location on a single screen is also known.

A technique is also known to determine the layout pattern of multiple images according to the composition pattern of multiple input image signals by determining the composition pattern based on the difference in the aspect ratio of each image.

### SUMMARY

In one embodiment of this invention, there is provided a non-transitory recording medium that storing, for example, a plurality of program codes. When the program codes are executed by one or more processors, there is a calculating of a scale ratio of each image transmitted from each site so that a subject size in each image is approximately the same. Furthermore, displaying each image that have been scaled by a teleconference service system at the scale ratio at terminal device at each site.

In one embodiment of this invention, there is provided an image processing system that includes, for example, circuitry that calculates a scale ratio of each image transmitted from each site so that a subject size in each image is approximately the same. The circuitry displays each image that has been scaled by a teleconference service system at the scale ratio at terminal device at each site.

In one embodiment of this invention, there is provided a teleconference service system that includes, for example, circuitry that calculates a scale ratio of each image transmitted from each site so that a subject size in each image is approximately the same. The circuitry displays each image that have been scaled by the teleconference service system at the scale ratio at terminal device at each site.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overview of the creation of a record for storing a screen of an application (hereinafter, referred to as an app) executed during a teleconference together with a panoramic image of surroundings according to embodiments of the present disclosure;

FIGS. 2A-2C are diagrams illustrating an example of multiple images transmitted by a terminal device;

FIG. 3 is a diagram illustrating an example of a flow of images sent and received in a record creation system;

FIG. 4 is a diagram illustrating a configuration of a record creation system according to embodiments of the present disclosure;

FIG. 5 is a diagram illustrating a hardware configuration of the information processing system, image processing system and a communication terminal according to embodiments of the present disclosure;

FIG. 6 is a diagram illustrating a hardware configuration of the meeting device according to embodiments of the present disclosure;

FIGS. 7A and 7B are diagrams illustrating an image capture range of the meeting device according to embodiments of the present disclosure;

FIG. 8 is a diagram illustrating a panoramic image and clipping of talker images according to embodiments of the present disclosure;

FIG. 9 is a diagram illustrating an example of a hardware configuration of the electronic whiteboard;

FIG. 10 is a block diagram illustrating a functional configuration, as individual blocks, of the communication terminal, the meeting device, and the information processing system of the record creation system according to Embodiment 1;

FIG. 11 is a diagram illustrating example items of information on a recorded video, stored in an information storage area;

FIG. 12 is a diagram illustrating an example of conference information managed by a communication management unit according to one embodiment;

FIG. 13 is a diagram illustrating an example of association information associating a conference identifier (ID) with a device ID, stored in an association storage area;

FIG. 14 is a block diagram illustrating, as individual blocks, a functional configuration of the electronic whiteboard according to one embodiment;

FIG. 15 is a diagram illustrating an example of information such as the device ID stored in a device information storage area;

FIG. 16 is a diagram illustrating an example of object information stored in an object information storage area;

FIG. 17 is a diagram illustrating an example of a functional block that divides the functions of an image processing system;

FIGS. 18A-18D are diagrams illustrating an example of average subject size and average size;

FIGS. 19A-19C are diagrams illustrating an example of the process of scaling an image based on its average size;

FIG. 20 is a diagram illustrating an example of a conference screen displayed by a teleconference application during a conference;

FIG. 21 is a diagram illustrating an example of a scaled-down of three images that do not fit into the display area;

FIG. 22 is a sequence diagram illustrating an example of the process of a terminal device at first site displaying the enlarged and reduced images of each site in a teleconference;

FIG. 23 is a flowchart illustrating an example of the process in which the image processing system calculates the scaling ratio of each image and determines the layout coordinates of each image in step S22;

FIG. 24 is a diagram illustrating an example of the average size setting screen displayed by the terminal device;

FIG. 25 is a diagram illustrating an example of a document display mode screen that displays a subject image in document display mode;

FIG. 26 is a diagram illustrating an example of the subject image to be cropped from each image whose size is adjusted so that the subject size is comparable;

FIG. 27 is a diagram illustrating an example of an initial screen displayed by an information recording application operating on the communication terminal after login;

FIG. 28 is a diagram illustrating an example of a recording setting screen displayed by the information recording application;

FIG. 29 is a diagram illustrating an example of a recording-in-progress screen displayed by the information recording application during recording;

FIG. 30 is a diagram illustrating an example of a conference list screen displayed by the information recording application;

FIGS. 31A and 31B are a sequence diagram illustrating an example of the procedure for an information recording application to record a panoramic image, talker image and application screen.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described in detail below. As used herein, the singular forms “a,” “an,” and “the” are intended to include the plural forms as well, unless the context clearly indicates otherwise.

Hereinafter, descriptions are given of an information device system and a method by the device system as an exemplary embodiment of the present disclosure.

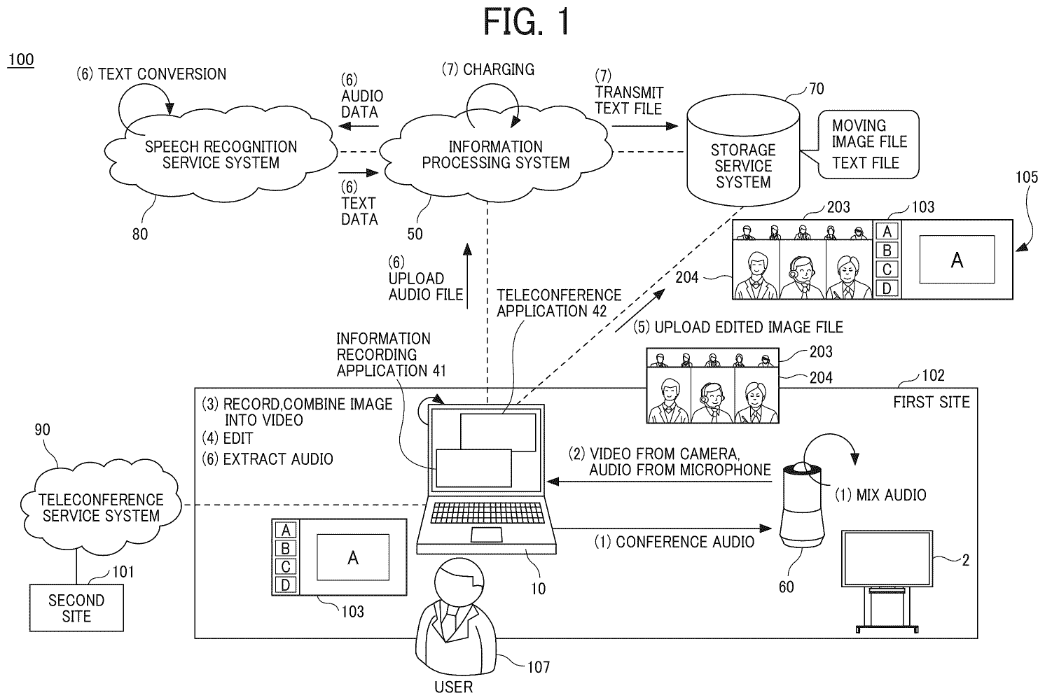

An overview of a method of creating minutes using a panoramic image and a screen of an application will be described with reference to FIG. 1.

FIG. 1 is a diagram illustrating an overview of creation of a record for storing a screen of an application executed during a teleconference, together with a panoramic image of the surroundings. As illustrated in FIG. 1, a user 107 at a first site 102 uses a teleconference service system 90 to have a teleconference with a user at a second site 101.

A record creation system 100 of this embodiment generates a record of the meeting (e.g., meeting minutes). The record includes a horizontal panoramic image (hereinafter “panoramic image”) acquired by processing information captured by a meeting device 60 equipped with an imaging means or camera capable of capturing 360° images of the surroundings, a microphone, and a speaker. The record also includes screens generated by applications (hereinafter “apps”) executed by the terminal device 10. The record creation system 100 combines audio data received by a teleconference application 42 and audio data obtained by the meeting device 60 together and includes the resultant audio data in the record. The overview will be described below.

1. On the communication terminal 10, an information recording application 41 described below and the teleconference application 42 are operating. Another application such as a document display application may also be operating. The information recording application 41 transmits audio data output by the communication terminal 10 (including audio data received by the teleconference application 42 from the second site 101) to the meeting device 60. The meeting device 60 mixes (combines) audio data obtained by the meeting device 60 and the audio data received by the teleconference application 42 together.

2. The meeting device 60 includes the microphone. Based on a direction from which the microphone receives sound, the meeting device 60 performs clipping of a portion including a person speaking (i.e., a talker) from the panoramic image to generate a talker image. The meeting device 60 transmits both the panoramic image and the talker image to the communication terminal 10.

3. The information recording application 41 operating on the communication terminal 10 displays a panoramic image 203 and talker images 204. The information recording application 41 combines the panoramic image 203 and the talker images 204 with a screen of a desired application (for example, a screen 103 of the teleconference application 42) selected by the user 107. For example, the information recording application 41 combines the panoramic image 203 and the talker images 204 with the screen 103 of the teleconference application 42 to generate a combined image 105 such that the panoramic image 203 and the talker image 204 are arranged on the left side and the screen 103 of the teleconference application 42 is arranged on the right side. Since the processing (3) is repeatedly performed, the resultant combined images 105 become a moving image (hereinafter, referred to as a combined video). The information recording application 41 attaches the combined audio data to the combined video to generate a video with sound.

In the present embodiment, an example of combining the panoramic image 203, the talker images 204, and the screen 103 of the teleconference application 42 together is described. Alternatively, the panoramic image 203, the talker images 204, and the screen 103 of the teleconference application 42 may be stored separately and arranged on a screen at the time of playback by the information recording application 41.

4. The information recording application 41 receives an editing operation (performed by the user 107 to cut off a portion not to be used), and completes the combined video. The combined video is a part of the record.

5. The information recording application 41 transmits the generated combined video (with sound) to a storage service system 70 for storage.

6. The information recording application 41 extracts the audio data from the combined video (or may keep the original audio data to be attached) and transmits the extracted audio data to an information processing system 50. The information processing system 50 receives the audio data and transmits the audio data to a speech recognition service system 80 that converts the audio data into text data. The speech recognition service system 80 converts the audio data into text data. The text data includes data indicating a time, from the start of recording, when a speaker made an utterance.

In the case of real-time conversion into text data, the meeting device 60 transmits the audio data directly to the information processing system 50. The information processing system 50 transmits the text data obtained by speech recognition to the information recording application 41 in real time

7. The information processing system 50 additionally stores the text data in the storage service system 70 storing the combined video. The text data is a part of the record.

The information processing system 50 performs a charging process for a user according to a service that is used. For example, the charge is calculated based on an amount of the text data, a file size of the combined video, a processing time, or the like.

As described above, the combined video displays the panoramic image 203 of the surroundings including the user 107 and the talker images 204 as well as the screen of the application such as the teleconference application 42 displayed in the teleconference. When a participant or someone who has not attended the teleconference views the combined video as the minutes of the teleconference, the teleconference is reproduced with the realism.

### Image Displayed by the Terminal Device

As described in FIG. 1, the terminal device 10 displays panoramic images and normal angle of view images of a second site relayed by the teleconference service system 90. The terminal device 10 simply displays these images on a single conference screen. However, the subject sizes (e.g., the size of a person's face) in each image vary. When the subject sizes in the images vary, if the terminal device simply displays each image, the subject sizes will be uneven and the images will be difficult to see.

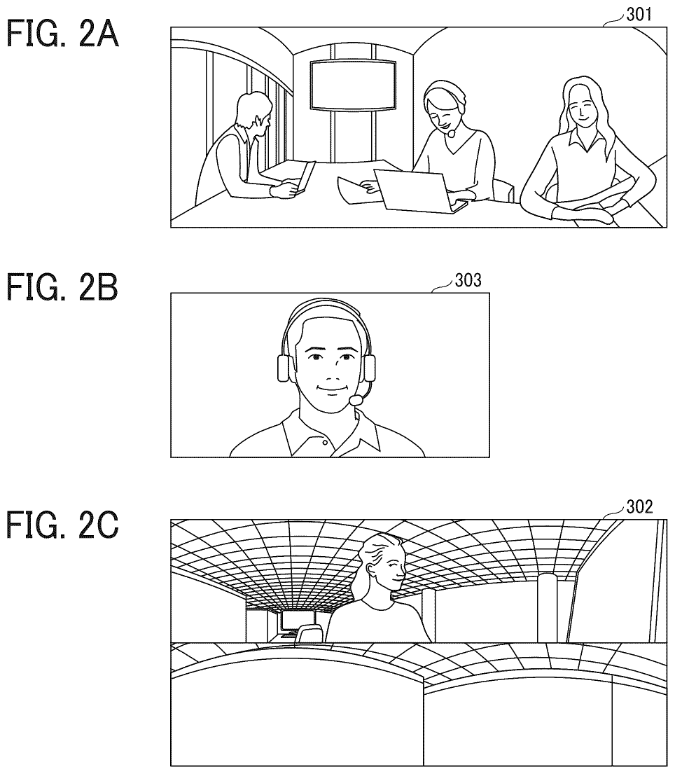

FIGS. 2A-2C show an example of multiple images transmitted by terminal device 10. Panoramic image 301 in FIG. 2A shows three participants, and the subject size is small. Image 303 in FIG. 2B shows one participant, but the subject size is large because the participant is close to the camera. Panoramic image 302 in FIG. 2C shows one participant, but the subject size is small because the participant is far away from the camera. When the terminal device 10 displays multiple such images on a single screen, the subject sizes will also be uneven.

Therefore, in this embodiment, the image processing system described later enlarges or reduces panoramic images 301, 302, and image 303 (hereinafter these may be collectively referred to as each image or simply as images) so that the subject sizes are approximately the same, as follows.
The image processing system detects the subject sizes appearing in panoramic images 301, 302, and image 303, and calculates the average subject size in each image. The detecting of the subject sizes can be performed in any desired manner, including using information described herein, and/or based on U.S. Pat. Nos. 8,325,997, 8,340,367, and/or 8,849,035, each of which are incorporated by reference.
The image processing system calculates an average size, which is the average of the average subject size of panoramic image 301, the average subject size of panoramic image 302, and the average subject size of image 303.
The image processing system calculates the scale ratio as the ratio between the average subject size and the average size of each of panoramic images 301, 302, and image 303.
The teleconference service system 90 enlarges or reduces panoramic images 301, 302, and image 303 using the scale ratio.

In this way, even if the subject sizes in the images transmitted from each location are different, each image can be enlarged or reduced so that the subject sizes in each image are approximately the same.

### Overview of the Process

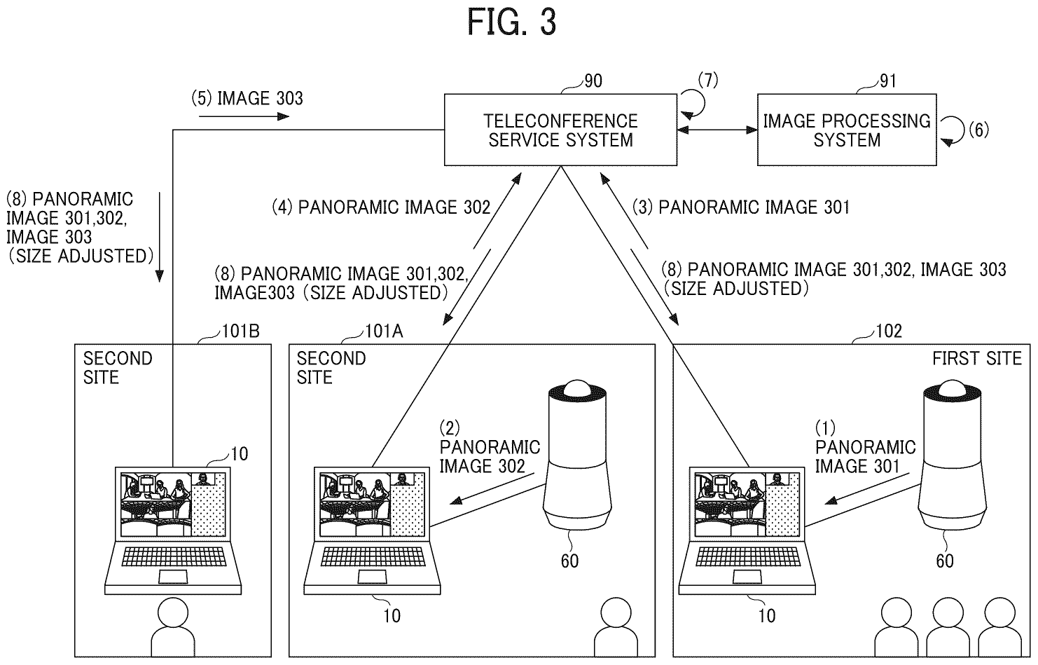

FIG. 3 is a diagram explaining the flow of images transmitted and received in the record information creation system 100.

Note that the system obtained by removing the terminal device 10, meeting device 60, and image processing system 91 used in the teleconference service system 90 from the record creation system 100 in FIG. 1 is referred to as the equipment system.
(1) The meeting device 60 at the first site 102 transmits the panoramic image 301 that is repeatedly captured to the terminal device 10.
(2) The meeting device 60 at the second site 101A transmits the panoramic image 302 that is repeatedly captured to the terminal device 10.
(3) The terminal device 10 at the first site 102 transmits the panoramic image 301 to the teleconference service system 90.
(4) The terminal device 10 at the second site 101 A transmits the panoramic image 302 to the teleconference service system 90.
(5) The terminal device 10 at second site 101B is not connected to the meeting device 60 but has a built-in camera. The terminal device 10 at the second site 101B transmits an image 303 with a normal angle of view to the teleconference service system 90.
(6) The teleconference service system 90 calls the image processing system 91 and requests the image processing system 91 to determine the scale ratio and the layout coordinates. The image processing system 91 calculates the scale ratios of the panoramic images 301, 302, and 303 so that the sizes of the subjects in the panoramic images 301, 302, and 303 are approximately the same. The image processing system 91 also determines the layout coordinates when the enlarged/reduced panoramic images 301, 302, and 303 are arranged on the screen.
(7) The teleconference service system 90 enlarges or reduces the panoramic images 301, 302, and 303 at the enlargement or reduction ratio calculated by the image processing system 91, and arranges them on the conference screen based on the layout coordinates.
(8) The teleconference service system 90 transmits conference screen on which the enlarged or reduced panoramic images 301, 302, and image 303 are arranged to the terminal device 10 at each site. The terminal device 10 at each site can display the panoramic images 301, 302, and image 303 that have been adjusted so that the subject sizes of the panoramic images 301, 302 are approximately the same.

In this way, the image processing system 91 can make the subject size uniform when displaying multiple images. For example, a panoramic image can capture many participants, but there is a risk that each person's face will be small. Even in such a case, the image processing system 91 determines the image scale ratio for each location so that the face sizes are approximately the same, allowing participants to take part in the conference while viewing the faces of other participants, who have similar face sizes.

### Terminology

The image of the surroundings of the meeting device acquired by the meeting device is image acquired by imaging the surrounding space (for example, a space of 180° to 360° in the horizontal direction) surrounding the meeting device, and refers to an image acquired by performing a predetermined process on the image of the curved surface captured by the meeting device. The predetermined process is various processes for creating the surrounding image from the captured information, such as flattening the image of the curved surface. The predetermined process may include a process for creating the surrounding image, a process for cutting out the talker image, and a process for combining the surrounding image and the talker image. In this embodiment, the surrounding image is described by the term panoramic image. A panoramic image is an image with a field of view of approximately 180° to 360° in the horizontal direction. It is not necessary for a single meeting device to capture a panoramic image, and multiple imaging devices with normal fields of view may be combined.

The record is information recorded by the information recording application 41 and is stored and saved so as to be viewable as information linked to the identification information of a certain conference (meeting), and includes, for example, the following information:
Video information generated based on screen information displayed by a selected application (such as a remote conference application) and image information of the device's surroundings acquired by the device.
Audio information acquired and synthesized by the remote conference application (terminal device) and the meeting device at the base during the conference (meeting).
Text information in which the acquired audio has been converted into text.
Other data and images that are relevant information related to the conference (meeting). For example, document files used during the conference, added notes, translated data of text data, and images and stroke data generated using a cloud electronic whiteboard service during the conference.

When the information recording application 41 records the screen of the teleconference application or the state of the conference at the site, the record may be the minutes of the conference that was held. The minutes are an example of record, and the record is called differently depending on the teleconference or the contents of the conference at the site, and may be called, for example, a record of communication or a record of the site situation. The record also includes files in multiple formats, such as recording files (combined image videos, etc.), audio files, text data (text data in which audio is recognized), document files, image files, and table files, and since the files are related to each other by the identification information of the conference, they can be viewed together or selectively in chronological order when viewed.

A tenant is a group of users (such as a company, local government, or some of these organizations) that has signed a contract to receive services from a service provider. In this embodiment, the creation of a record and conversion to text data are performed because the tenant has signed a contract with the service provider.

Telecommunication refers to communicating through audio and video using software and terminal devices with people at a physically distant site. One example of telecommunication is a teleconference, which may also be called a meeting, a conference, an arrangement, a consultation, an application for a contract, a gathering, a get-together, a seminar, a course, a study group, a seminar, a training session, etc.

A site is a place that is the site of activities. An example of a site is a conference room. A conference room is a room that is set up primarily for use for meetings. A site can also be a variety of other locations, such as a home, a reception desk, a store, a warehouse, or an outdoor site, as long as it is a place or space where terminal equipment, devices, etc. can be installed.

A subject refers to a specific person or object in an image, or a part of the person or object. In this embodiment, the subject is a person or object, or a part of the person or object, that you want to display in a uniform size on the conference screen. In this embodiment, the face of a participant will be used as an example of the subject.

The term “scale” refers to enlarging or reducing an image. In this embodiment, the enlargement or reduction of each image transmitted from a location will be described as an example.

### Example of System Configuration

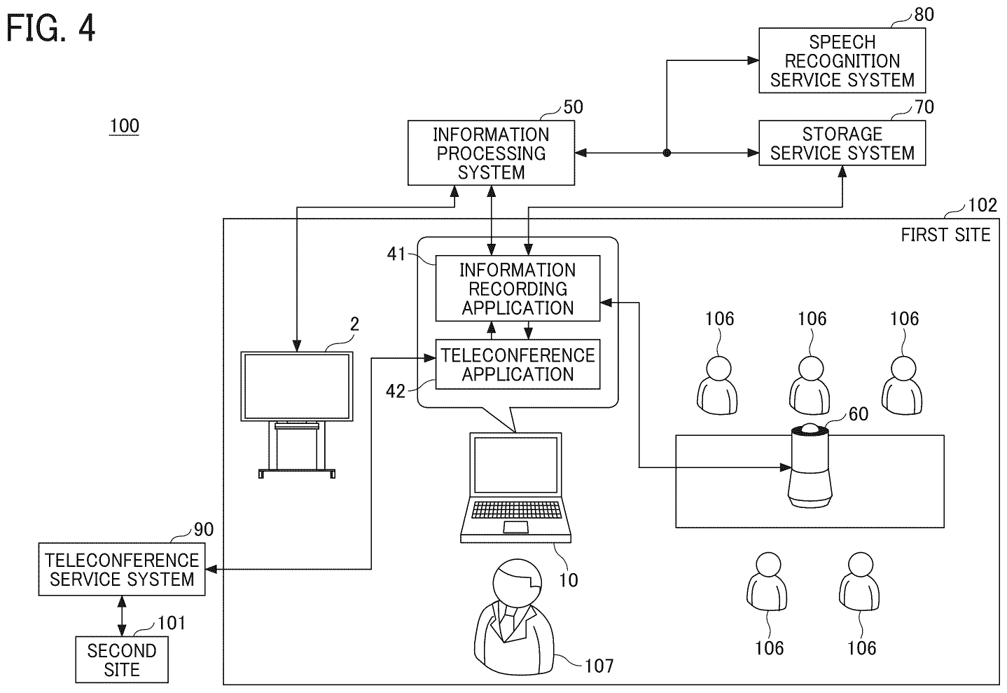

A system configuration of the record creation system 100 will be described with reference to FIG. 4. FIG. 4 illustrates an example of the configuration of the record creation system 100. FIG. 4 illustrates one site (the first site 102 on which the meeting device 60 is located) among a plurality of sites between which a teleconference is held. The communication terminal 10 at the first site 102 communicates with the information processing system 50, the storage service system 70, and the teleconference service system 90 via a network. The meeting device 60 and the electronic whiteboard 2 are disposed at the first site 102. The communication terminal 10 is connected to the meeting device 60 via, for example, a Universal Serial Bus (USB) cable to communicate therewith. The meeting device 60, the electronic whiteboard 2, and the information processing system 50 operate as a device management system.

At least the information recording application 41 and the teleconference application 42 operate on the communication terminal 10. The teleconference application 42 can communicate with the communication terminal 10 at the second site 101 via the teleconference service system 90 that resides on the network to allow users at the remote sites to participate in a teleconference. The information recording application 41 uses functions of the information processing system 50 and the meeting device 60 to generate the record of the teleconference hosted by the teleconference application 42.

In the present embodiment, a description is given of an example in which the record of a teleconference is generated. However, in another example, the conference is not necessarily held among remote sites. That is, aspects of the present disclosure are applicable to a conference held among the participants present at one site. In this case, the image captured by the meeting device 60 and the audio received by the meeting device 60 are independently stored without being combined. The rest of the processing performed by the information recording application 41 is similar to that of the present embodiment.

The communication terminal 10 includes a built-in (or external) camera having an ordinary angle of view. The camera of the communication terminal 10 captures an image of a front space including the user 107 who operates the communication terminal 10. Images captured by the camera having an ordinary angle of view are not panoramic images. In the present embodiment, the built-in camera having the ordinary angle of view primarily captures planar images that are not curved like spherical images. Thus, the user can participate in a teleconference using the teleconference application 42 as usual without paying attention to the information recording application 41. The information recording application 41 and the meeting device 60 do not affect the teleconference application 42 except for an increase in the processing load of the communication terminal 10. The teleconference application 42 can transmit a panoramic image or a talker image captured by the meeting device 60 to the teleconference service system 90.

The information recording application 41 communicates with the meeting device 60 to generate a record of a conference. The information recording application 41 also synthesizes audio received by the meeting device 60 and audio received by the teleconference application 42 from another site. The meeting device 60 is a device for a meeting, including an image-capturing device that captures a panoramic image, a microphone, and a speaker. The camera of the communication terminal 10 can capture an image of only a limited range of the front space. In contrast, the meeting device 60 can capture an image of the entire surroundings (not necessarily the entire surroundings) around the meeting device 60. The meeting device 60 can keep a plurality of participants 106 illustrated in FIG. 4 within the angle of view.

In addition, the meeting device 60 cuts out a talker image from a panoramic image. The meeting device 60 is placed on a table in FIG. 4, but may be placed anywhere in the first site 102. Since the meeting device 60 can capture a spherical image, the meeting device 60 may be disposed on a ceiling, for example.

The information recording application 41 displays a list of applications executing on the communication terminal 10, combines images for the above-described record (generates the combined video), plays the combined video, receives editing, and the like. Further, the information recording application 41 displays a list of teleconferences already held or are to be held in the future. The list of teleconferences is used in information on the record to allow the user to link a teleconference with the record.

The teleconference application 42 is an application that enables a terminal device to remotely communicate with other terminal devices by establishing a communication connection with other terminal devices at the second site 102, sending and receiving images and audio, displaying images and outputting audio, etc. The teleconference application can also be called a telecommunication application, a remote information common application, etc.

The information recording application 41 and the teleconference application 42 each may be a web application or a native application. A web application is an application in which a program on a web server cooperates with a program on a web browser to perform processing, and is not to be installed on the communication terminal 10. A native application is an application that is installed and used on the communication terminal 10. In the present embodiment, both the information recording application 41 and the teleconference application 42 are described as native applications.

The communication terminal 10 may be a general-purpose information processing apparatus having a communication function, such as a personal computer (PC), a smartphone, or a tablet terminal, for example. Alternatively, the communication terminal 10 is, for example, an electronic whiteboard, a game console, a personal digital assistant (PDA), a wearable PC, a car navigation system, an industrial machine, a medical device, or a networked home appliance. The communication terminal 10 may be any apparatus on which the information recording application 41 and the teleconference application 42 operate.

The electronic whiteboard 2 displays, on a display, data handwritten on a touch panel with an input device such as a pen or a finger. The electronic whiteboard 2 can communicate with the communication terminal 10 or the like in a wired or wireless manner, and capture a screen displayed by the communication terminal 10 and display the screen on the display. The electronic whiteboard 2 can convert hand-written image data into text data, and share information displayed on the display with the electronic whiteboard 2 at another site. The electronic whiteboard 2 may be a whiteboard, not including a touch panel, onto which a projector projects an image. The electronic whiteboard 2 may be a tablet terminal, a laptop computer or PC, a PDA, a game console, or the like including a touch panel.

The electronic whiteboard 2 can communicate with the information processing system 50. For example, after being powered on, the electronic whiteboard 2 performs polling on the information processing system 50 to receive information from the information processing system 50.

The information processing system 50 is implemented by one or more information processing apparatuses deployed over a network. The information processing system 50 includes one or more server applications that perform processing in cooperation with the information recording application 41, and an infrastructure service. The server applications manage, for example, a list of teleconferences, records of teleconferences, and various settings and storage paths.

The infrastructure service performs user authentication, makes a contract, performs charging processing, and the like.

All or some of the functions of the information processing system 50 may reside in a cloud environment or in an on-premises environment. The information processing system 50 may be implemented by a plurality of server apparatuses or a single information processing apparatus. For example, the server applications and the infrastructure service may be provided by separate information processing apparatuses. Further, each function of the server applications may be provided by an individual information processing apparatus. The information processing system 50 may be integral with the storage service system 70 and the speech recognition service system 80 described below.

The storage service system 70 is a storage means on a network, and provides a storage service for accepting the storage of files and the like. Examples of the storage service system 70 include MICROSOFT ONEDRIVE, GOOGLE WORKSPACE, and DROPBOX. The storage service system 70 may be on-premises network-attached storage (NAS) or the like, or any desired storage device or server.

The speech recognition service system 80 provides a service of speech recognition on audio data and converting the audio data into text data. The speech recognition service system 80 may be a general-purpose commercial service or a part of the functions of the information processing system 50. Furthermore, the speech recognition service system 80 may be set to use a different service system for each user, tenant, or conference.

### Example of Hardware Configuration

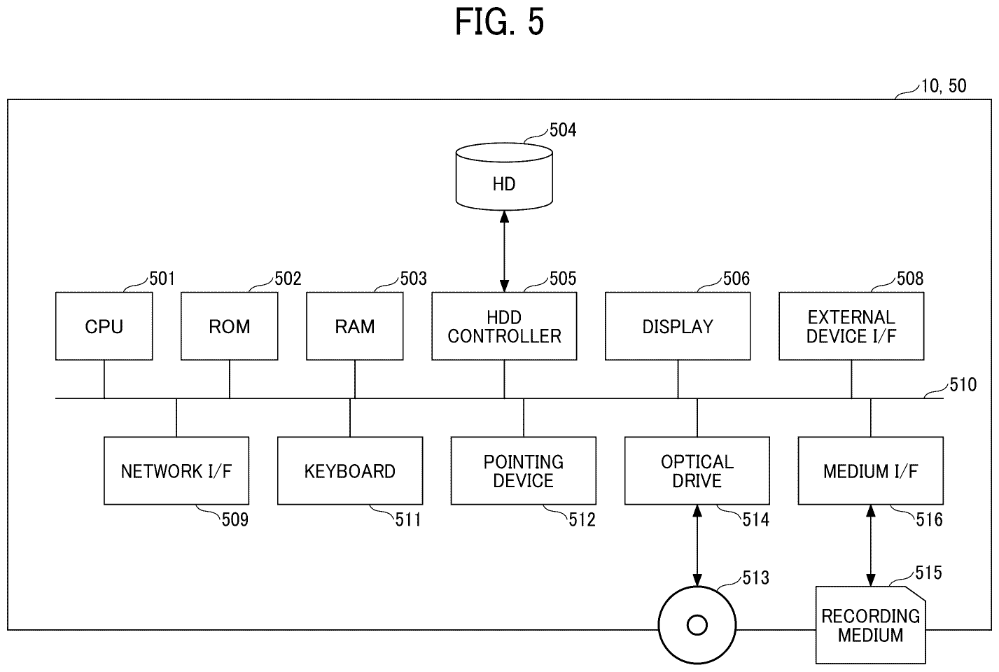

A hardware configuration of the information processing system 50, image processing system 91 and the communication terminal 10 according to the present embodiment will be described with reference to FIG. 5.

### Information Processing System and Communication Terminal

FIG. 5 is a diagram illustrating an example of a hardware configuration of the information processing system 50 and the communication terminal 10 according to the present embodiment. As illustrated in FIG. 5, the information processing system 50 and the communication terminal 10 each are implemented by a computer and each include a central processing unit (CPU) 501, a read-only memory (ROM) 502, a random access memory (RAM) 503, a hard disk (HD) 504, a hard disk drive (HDD) controller 505, a display 506, an external device interface (I/F) 508, a network I/F 509, a bus line 510, a keyboard 511, a pointing device 512, an optical drive 514, and a medium I/F 516.

The CPU 501 controls the entire operation of the information processing system 50 and the communication terminal 10. The ROM 502 stores programs such as an initial program loader (IPL) to boot the CPU 501. The RAM 503 is used as a work area for the CPU 501. The HD 504 stores various kinds of data such as a program. The HDD controller 505 controls reading or writing of various kinds of data from or to the HD 504 under control of the CPU 501. The display 506 displays various kinds of information such as a cursor, a menu, a window, characters, or an image. The external device I/F 508 is an interface for connecting various external devices. Examples of the external devices in this case include, but are not limited to, a USB memory and a printer. The network I/F 509 is an interface for performing data communication via a network. The bus line 510 is, for example, an address bus or a data bus for electrically connecting the components such as the CPU 501 illustrated in FIG. 5 to one another.

The keyboard 511 is a kind of an input device including a plurality of keys used for inputting characters, numerical values, various instructions, or the like. The pointing device 512 is a kind of an input device used to select or execute various instructions, select a target for processing, or move a cursor. The optical drive 514 controls the reading or writing of various kinds of data from or to an optical recording medium 513 that is an example of a removable recording medium. The optical recording medium 513 may be a compact disc (CD), a digital versatile disc (DVD), a BLU-RAY disc, or the like. The medium I/F 516 controls reading or writing (storing) of data from or to a recording medium 515 such as a flash memory.

### Meeting Device

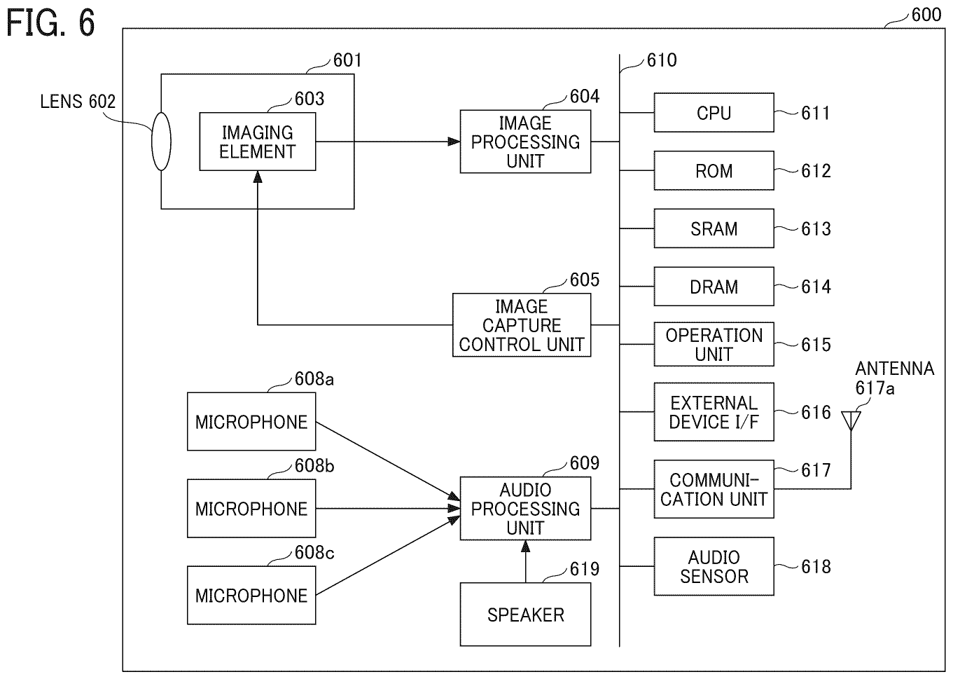

A hardware configuration of the meeting device 60 will be described with reference to FIG. 6. FIG. 6 is a block diagram illustrating an example of a hardware configuration of the meeting device 60 that can generate a 360-degree video of surroundings according to the present embodiment. In the following description, the meeting device 60 is assumed to be a device that uses an imaging element to capture a 360-degree image of the surroundings of the meeting device 60 at a predetermined height, to produce a video. The number of imaging elements may be one or two or more. The meeting device 60 is not necessarily a dedicated device and may be a PC, a digital camera, a smartphone, or the like to which an imaging unit for a 360-degree video is externally attached so as to implement substantially the same functions as the meeting device 60.

As illustrated in FIG. 6, the meeting device 60 includes an imaging unit 601, an image processing unit 604, an image capture control unit 605, microphones 608a, 608b, and 608c (collectively “microphones 608”), an audio processing unit 609, a CPU 611, a ROM 612, a static random access memory (SRAM) 613, a dynamic random access memory (DRAM) 614, an operation device 615, an external device I/F 616, a communication unit 617, an antenna 617a, and an audio sensor 618. The external device I/F 616 includes a socket terminal for Micro-USB.

The imaging unit 601 may be a camera such as digital camera or a web cam, and includes a wide-angle lens 602 (so-called fisheye lens) having an angle of view of 360 degrees to form a hemispherical image, and an imaging element 603 (image sensor) provided for the wide-angle lens 602. The imaging element 603 includes an image sensor such as a complementary metal oxide semiconductor (CMOS) sensor or a charge coupled device (CCD) sensor, a timing generation circuit, and a group of registers. The image sensor converts an optical image formed by the wide-angle lens 602 into an electric signal to output image data. The timing generation circuit generates horizontal or vertical synchronization signals, pixel clocks, and the like for the image sensor. Various commands, parameters, and the like for operations of the imaging element are set in the group of registers. The imaging unit 601 may be a 360° camera, which is an example of an imaging means capable of capturing an image of the 360° surroundings of the meeting device 60.

The imaging element 603 (image sensor) of the imaging unit 601 is connected to the image processing unit 604 via a parallel I/F bus. On the other hand, the imaging element 603 of the imaging unit 601 is connected to the image capture control unit 605 via a serial I/F bus such as an inter-integrated circuit (I2C) bus. The image processing unit 604, the image capture control unit 605, and the audio processing unit 609, each of which may be implemented by a circuit, are connected to the CPU 611 via a bus 610. The ROM 612, the SRAM 613, the DRAM 614, the operation device 615, the external device I/F 616, the communication unit 617, the sound sensor 618, and the like are also connected to the bus 610.

The image processing unit 604 can be implemented as image processing circuitry and obtains image data output from the imaging element 603 through the parallel I/F bus and performs predetermined processing on the image data to generate data of a panoramic image and data of a talker image from a fisheye image. The image processing unit 604 combines the panoramic image and the talker image or the like together to output a single video (moving image).

The image capture control unit 605 can be implemented as image capture control circuitry and usually serves as a master device, whereas the imaging element 603 usually serves as a slave device. The image capture control unit 605 sets commands and the like in the groups of registers of the imaging element 603 through the I2C bus. The image capture control unit 605 receives the commands and the like from the CPU 611. The image capture control unit 605 obtains status data and the like in the groups of registers of the imaging element 603 through the I2C bus. The image capture control unit 605 then sends the obtained data to the CPU 611.

The image capture control unit 605 instructs the imaging element 603 to output image data at a timing when an image-capturing start button of the operation device 615 is pressed or a timing when the image capture control unit 605 receives an image-capturing start instruction from the CPU 611. In some cases, the meeting device 60 supports a preview display function and a video display function of a display (e.g., a display of a PC or a smartphone). In this case, the image data is consecutively output from the imaging elements 603 at a predetermined frame rate (frames per minute).

When the meeting device 60 includes a plurality of imaging elements 603, the image capture control unit 605 operates in cooperation with the CPU 611 to synchronize the output timing of image data from the plurality of imaging elements 603. In the present embodiment, the meeting device 60 does not include a display. However, in some embodiments, the meeting device 60 includes a display.

The microphones 608a, 608b, and 608c (hereinafter, referred to as microphones 608 when no distinction is made) convert sound into sound (signal) data. The audio processing unit 609 can be implemented as audio processing circuitry and receives the audio data output from the microphones 608a, 608b, and 608c via an I/F bus, mixes (combines) the audio data, and performs predetermined processing on the audio data. The audio processing unit 609 also determines a direction of an audio source (talker) from a level of the audio (volume) input from the microphones 608a to 608c. The speaker 619 converts the input audio data into audio.

The CPU 611 controls the entire operations of the meeting device 60 and performs desirable processing. The ROM 612 stores various programs for operating the meeting device 60. Each of the SRAM 613 and the DRAM 614 is a work memory and stores programs being executed by the CPU 611 or data being processed. In particular, in one example, the DRAM 614 stores image data being processed by the image processing unit 604 and processed data of an equirectangular projection image.

The operation unit or device 615 collectively refers to various operation buttons such as an image-capturing start button or a user interface that includes a touch screen and/or a display. The user operates the operation device 615 to start image-capturing or recording, power on or off the meeting device 60, establish a connection, perform communication, and input settings such as various image-capturing modes and image-capturing conditions

The external device I/F 616 is an interface for connecting various external devices. The external device in this case is, for example, a personal computer (PC), display, projector, electronic whiteboard, etc. The external device I/F 616 may include, for example, a USB terminal, an HDMI (registered trademark) terminal, etc. The video data or still image data stored in the DRAM 614 is transmitted to an external communication terminal or stored in an external medium via the external device I/F 616. In addition, the meeting device 60 may use multiple external device I/F 616 to, for example, transmit image information captured by the meeting device 60 to a PC via USB for recording, while also acquiring images from the PC to the meeting device 60 (e.g., screen information to be displayed in a teleconference application, etc.), and further transmit the images from the meeting device 60 to other external devices (displays, projectors, electronic whiteboards, etc.) via HDMI (registered trademark) for display.

The communication unit or circuitry 617 is implemented by, for example, a network interface circuit. The communication unit 617 may communicate with a cloud server via the Internet using a wireless communication technology such as Wireless Fidelity (Wi-Fi) via an antenna 617a of the meeting device 60 and transmit the video data and the image data stored in the DRAM 614 to the cloud server. Further, the communication unit 617 may be able to communicate with nearby devices using a short-range wireless communication technology such as BLUETOOTH LOW ENERGY (BLE) or the near field communication (NFC).

The sound or audio sensor 618 is a sensor that acquires 360-degree audio data in order to identify the direction from which a loud sound is input within a 360-degree space around the meeting device 60 (on a horizontal plane). The audio processing unit 609 determines the direction in which the volume of the sound is highest, based on the input 360-degree audio parameter, and outputs the direction from which the sound is input within the 360-degree space.

Note that another sensor (such as an azimuth/accelerometer or a Global Positioning System (GPS)) may calculate an azimuth, a position, an angle, an acceleration, or the like and use the calculated azimuth, position, angle, acceleration, or the like in image correction or position information addition.

The image processing unit 604 generates a panoramic image in the following method. The CPU 611 performs predetermined camera image processing such as Bayer interpolation (red green blue (RGB) supplementation processing) on raw data input by an image sensor that inputs a spherical image, to generate a wide-angle image (a video including curved-surface images). Further, the CPU 611 performs unwrapping processing (distortion correction processing) on the wide-angle image lens (the video including curved-surface images) to generate a panoramic image (a video including planar images) of the surroundings in 360 degrees around the meeting device 60.

The CPU 611 generates a talker image according to a method below. The CPU 611 generates a talker image on which a talker is cut out from a panoramic image (a video including planar images) of the surroundings in 360 degrees around the meeting device 60. The CPU 611 cuts out, from the panoramic image, a talker image corresponding the direction of the talker which is the input direction of the audio determined from 360 degrees, using the audio sensor 618 and the audio processing unit 609. For cutting out an image of a person based on the input direction of the audio, specifically, the CPU 611 cuts out a 30-degree portion around the input direction of the audio identified from 360 degrees, and performs face detection on the 30-degree portion to cut out the talker image. The detecting of faces can be performed in any desired manner, including using information described herein, and/or based on U.S. Pat. Nos. 8,325,997, 8,340,367, and/or 8,849,035, each of which are incorporated by reference. The CPU 611 further identifies talker images of a predetermined number of persons (e.g., three persons) who have most recently spoken, among talker images cut out from the panoramic image.

The panoramic image and one or more talker images may be individually transmitted to the information recording application 41. Alternatively, the meeting device 60 may generate one image combined from the panoramic image and the one or more talker images and transmit the one image to the information recording application 41. In the present embodiment, the panoramic image and one or more talker images are individually transmitted from the meeting device 60 to the information recording application 41.

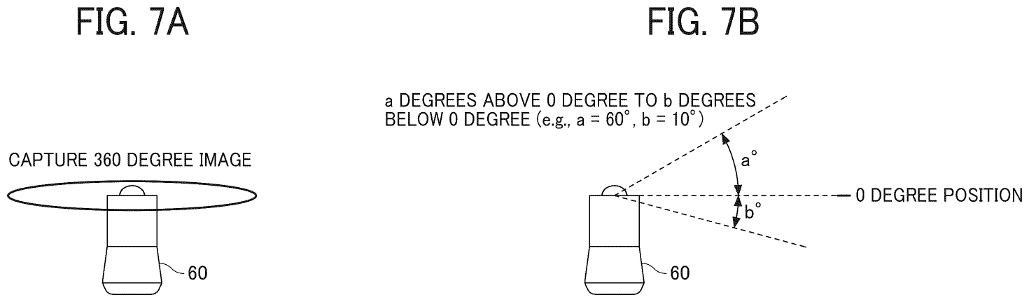

FIG. 7A and FIG. 7B are diagrams illustrating an image capture range of the meeting device 60. As illustrated in FIG. 7A, the meeting device 60 captures an image of a 360-degree range in the horizontal direction. As illustrated in FIG. 7B, the meeting device 60 has an image capture range extending predetermined angles up and down from a 0-degree direction that is horizontal to the height of the meeting device 60.

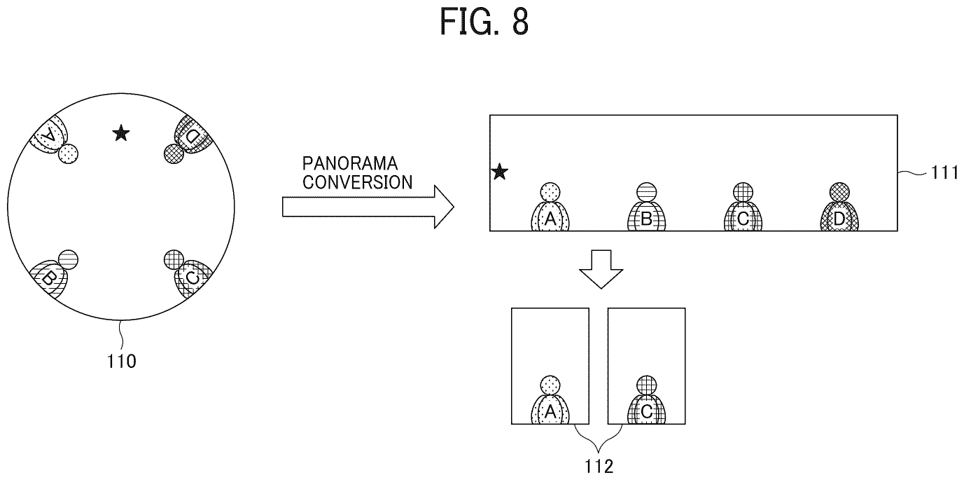

FIG. 8 is a schematic diagram illustrating a panoramic image and cut out talker images obtained by cutting out from the panoramic image. As illustrated in FIG. 8, an image captured by the meeting device 60 is a portion 110 of a sphere, and thus has a three-dimensional shape. As illustrated in FIG. 8B, the meeting device 60 divides angles of view into the predetermined degrees up and down and by the predetermined angle in the horizontal direction to perform perspective projection conversion on each of the angles of view. A predetermined number of planar images are obtained by performing the perspective projection conversion on the entire 360-degree range in the horizontal direction without gaps. Thus, a panoramic image 203 is obtained by laterally connecting the predetermined number of planar images. The meeting device 60 performs face detection on a predetermined range around the sound direction in the panoramic image 203, and clips 15-degree leftward and rightward ranges from the center of the face (i.e., a 30-degree range in total) to generate a talker image 204.

### Electronic Whiteboard

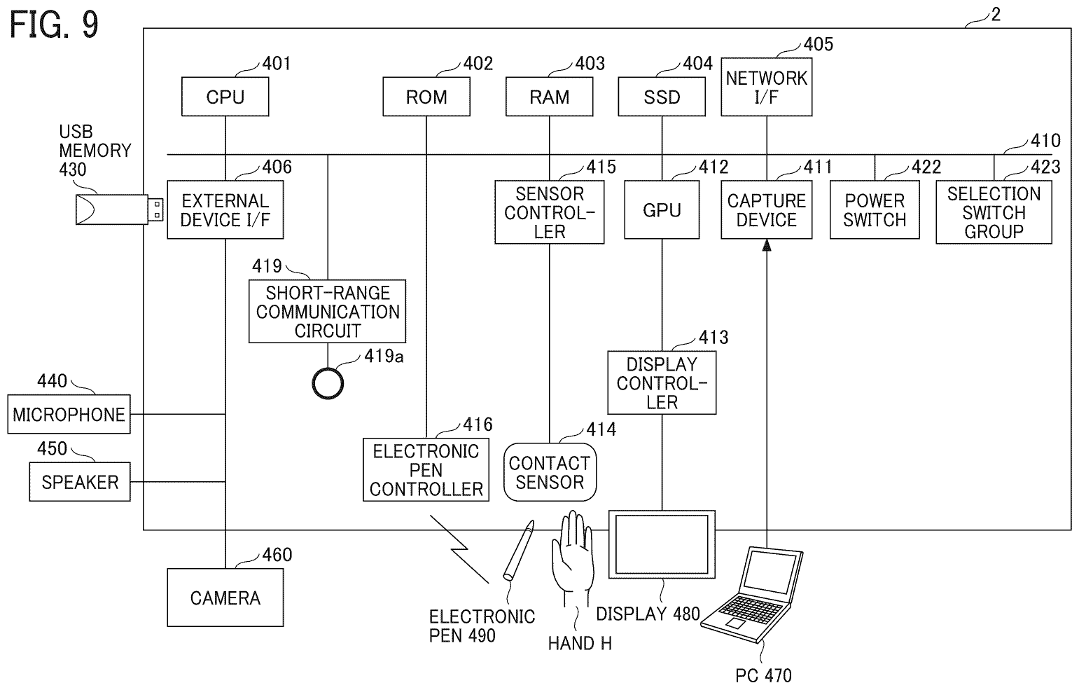

FIG. 9 is a diagram illustrating an example of a hardware configuration of the electronic whiteboard 2. As illustrated in FIG. 9, the electronic whiteboard 2 includes a CPU 401, a ROM 402, a RAM 403, a solid state drive (SSD) 404, a network I/F 405, and an external device I/F 406.

The CPU 401 controls operations of the entire electronic whiteboard 2. The ROM 402 stores a program such as an IPL (“Initial Program Load”) to boot an operating system (OS). The RAM 403 is used as a work area for the CPU 401. The SSD 404 stores various kinds of data such as a program for the electronic whiteboard 2. The network I/F 405 controls communication with a communication network. The external device I/F 406 is an interface for connecting various external devices. Examples of the external devices in this case include, but not limited to, a USB memory 430 and externally-connected devices such as a microphone 440, a speaker 450, and a camera 460.

The electronic whiteboard 2 further includes a capture device or circuitry 411, a graphics processing unit (GPU) 412, a display controller 413, a contact sensor 414, a sensor controller 415, an electronic pen controller 416, a short-range communication circuit 419, an antenna 419a of the short-range communication circuit 419, a power switch 422, and a selection switch group 423.

The capture device 411 displays information displayed on the display of an external PC (Personal Computer) 470 as a still image or a video. The GPU 412 is a semiconductor chip that exclusively handles graphics. The display controller 413 controls and manages displaying of a screen to display an image output from the GPU 412 on a display 480. The contact sensor 414 detects a touch of an electronic pen 490, a user's hand H, or the like onto the display 480. The sensor controller 415 controls processing of the contact sensor 414. The contact sensor 414 receives a touch input and detects coordinates of the touch input according to the infrared blocking system. The method of inputting and detecting these coordinates will now be described. Two light receiving and emitting devices installed at both ends of the upper side of the display 480 emit a plurality of infrared rays parallel to the display 480, and receive the light reflected by a reflecting member provided around the periphery of the display 480 and returning along the same optical path as the light emitted by the light receiving element.

The contact sensor 414 outputs, to the sensor controller 415, position information (a position on the light-receiving elements) of an infrared ray that is emitted from the two light receiving and emitting devices and then blocked by an object. Based on the position information of the infrared ray, the sensor controller 415 detects specific coordinates of the position touched by the object. The electronic pen controller 416 communicates with the electronic pen 490 by BLUETOOTH to detect a touch by the tip or bottom of the electronic pen 490 to the display 480. The short-range communication circuit 419 is a communication circuit that is compliant with Near Field Communication (NFC), BLUETOOTH, or the like. The power switch 422 is used for powering on and off the electronic whiteboard 2. The selection switch group 423 is a group of switches for adjusting brightness, hue, etc., of display on the display 480.

The electronic whiteboard 2 further includes a bus line 410. The bus line 410 is, for example, an address bus or a data bus for electrically connecting the components such as the CPU 401 illustrated in FIG. 8 to one another.

Note that the contact sensor 414 is not limited to a touch sensor of the infrared blocking system, and may be a capacitive touch panel that detects a change in capacitance to identify the touched position. The contact sensor 414 may be a resistive-film touch panel that identifies the touched position based on a change in voltage across two opposing resistive films. The contact sensor 414 may be an electromagnetic inductive touch panel that detects electromagnetic induction generated by a touch of an object onto a display to identify the touched position. In addition to the devices described above, various types of detection devices may be used as the contact sensor 414. The electronic pen controller 416 may determine whether there is a touch of another part of the electronic pen 490 such as a part of the electronic pen 490 held by the user as well as the tip and the bottom of the electronic pen 490.

### Functions

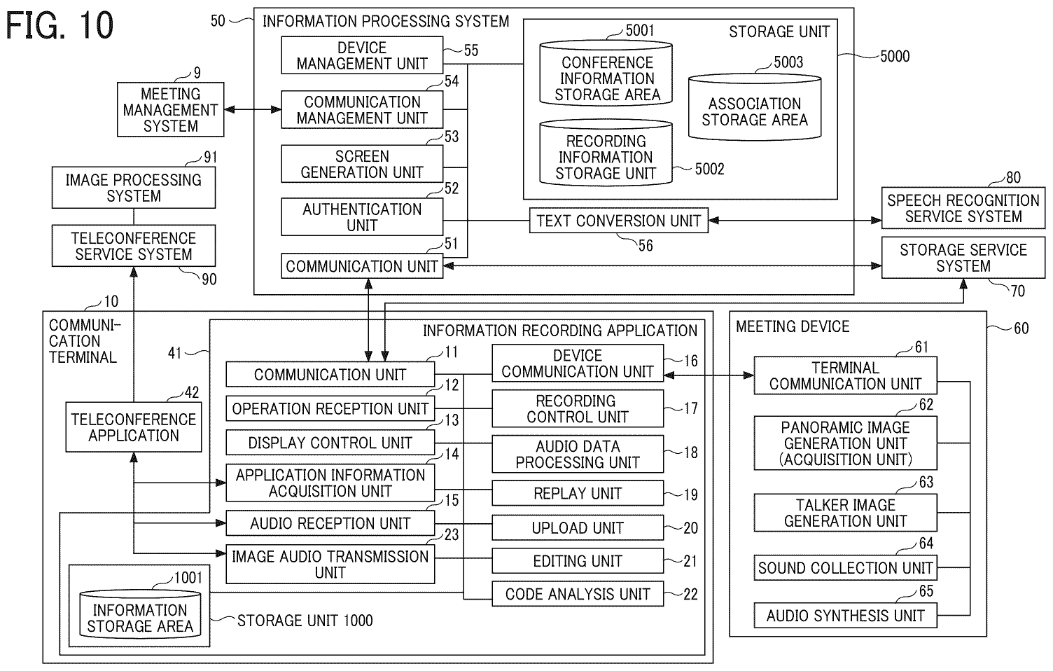

A description is now given of a functional configuration of the record creation system 100, with reference to FIG. 10. FIG. 10 is a block diagram illustrating a functional configuration of the communication terminal 10, the meeting device 60, and the information processing system 50 of the record creation system 100 according to the present embodiment.

### Communication Terminal

The information recording application 41 operating on the communication terminal 10 implements a communication unit 11, an operation reception unit 12, a display control unit 13, an app screen acquisition unit 14, an audio reception unit 15, a device communication unit 16, a recording control unit 17, an audio data processing unit 18, a replay unit 19, an upload unit 20, an editing unit 21, a code analysis unit 22, and a time measuring unit 25. These units of functions on the communication terminal 10 are implemented by or caused to function by one or more of the components illustrated in FIG. 5 operating in accordance with instructions from the CPU 501 according to the information recording application 41 loaded from the HD 504 to the RAM 503. The communication terminal 10 also includes a memory or storage unit 1000 implemented by the HD 504 or the like illustrated in FIG. 5. The storage unit 1000 includes an information storage area 1001, which is implemented by a database, for example.

The communication unit 11 transmits and receives various types of information to and from the information processing system 50 via a communication network.

The operation reception unit 12 receives various operations input to the information recording application 41.

The display control unit 13 control display of various screens serving as user interfaces in the information recording application 41 in accordance with screen transitions set in the information recording application 41.

The app screen acquisition unit 14 acquires a desktop screen or a screen displayed by an application selected by a user from an operating system (OS) or the like. When the application selected by the user is the teleconference application 42, a screen (including e.g., images captured by the terminal device cameras of terminal users at each site, images displayed on shared materials, images including participant icons and names, etc.) generated by the teleconference application 42 is obtained. The screen displayed by an app (app screen) is information that a running application displays as a window and that an information recording application acquires as an image. The application window is drawn with the window area as an area of the entire desktop image and displayed on a monitor, etc. The screen displayed by an app can be acquired by other applications (such as an information recording application) as an image file or a recorded file including multiple consecutive images via an API of the OS (Operating System) or an API of the displaying app, etc. In addition, screen information of the desktop screen is information including an image of the desktop screen generated by the OS, and can similarly be acquired as an image file or recorded file via the API of the OS. The format of these image files may be bitmap, PNG, or other formats. The format of the recorded file may be MP4 or other formats.

The audio reception unit 15 acquires audio data received by the communication terminal 10 from the teleconference application 42 in a teleconference. In addition, the audio reception unit 15 passes the audio data acquired by the meeting device 60 to the teleconference application 42. Note that the audio data acquired by the audio reception unit 15 does not include sound collected by the communication terminal 10. This is because the meeting device 60 collects sound.

The device communication unit 16 communicates with the meeting device 60 using a USB cable or the like. Alternatively, the device communication unit 16 may communicate with the meeting device 60 via a wireless local area network (LAN) or BLUETOOTH. The device communication unit 16 receives the panoramic image and the talker image from the meeting device 60, and transmits the audio data acquired by the audio reception unit 15 to the meeting device 60. The device communication unit 16 receives the audio data combined by the meeting device 60.

The recording control unit 17 combines the panoramic image and the talker image received by the device communication unit 16 and the screen of the application acquired by the app screen acquisition unit 14 together, to generate a combined image. The recording control unit 17 connects the repeatedly generated combined images in time series to generate a combined video, and attaches the audio data combined by the meeting device 60 to the combined video, to generate a combined video with sound. The panoramic image and the talker image may be combined by the meeting device 60. The recording control unit 17 may also store videos including each image, such as the panoramic image, the talker image, the app screen, and an image including a panoramic image and a talker image, as separate recording files in the storage service system 70. In that case, the recording control unit 17 may call up the panoramic video, the talker video, the video of the app screen, and the combined video of the panoramic image and the talker image when viewing, and display them on a single display screen.

The audio data processing unit 18 requests the information processing system 50 to convert, into text data, the audio data extracted by the recording control unit 17 from the combined video with sound or the combined audio data received from the meeting device 60.

The replay unit 19 plays the combined video. The combined video is stored in the communication terminal 10 during recording, and then uploaded to the information processing system 50.

After the teleconference ends, the upload unit 20 transmits the combined video to the information processing system 50.

The editing unit 21 edits the combined video (e.g., deletes a portion of the combined video or combines a plurality of combined videos) in accordance with a user operation.

The code analysis unit 22 detects a two-dimensional code included in the panoramic image and analyzes the two-dimensional code to acquire a conference participation information. The conference participation information includes information that the device can be used in the conference, the device identification information of the electronic whiteboard 2 stored in the device information storage unit or memory 3001 described below, the conference ID (selected by the user), the IP address of the electronic whiteboard 2, etc. The device identification information may be a serial number or a UUID (Universally Unique Identifier), etc. The device identification information may be set by the user. The conference ID is assigned when the conference is booked, or when recording begins. The conference ID may be linked to the conference ID determined by the remote conference service system.

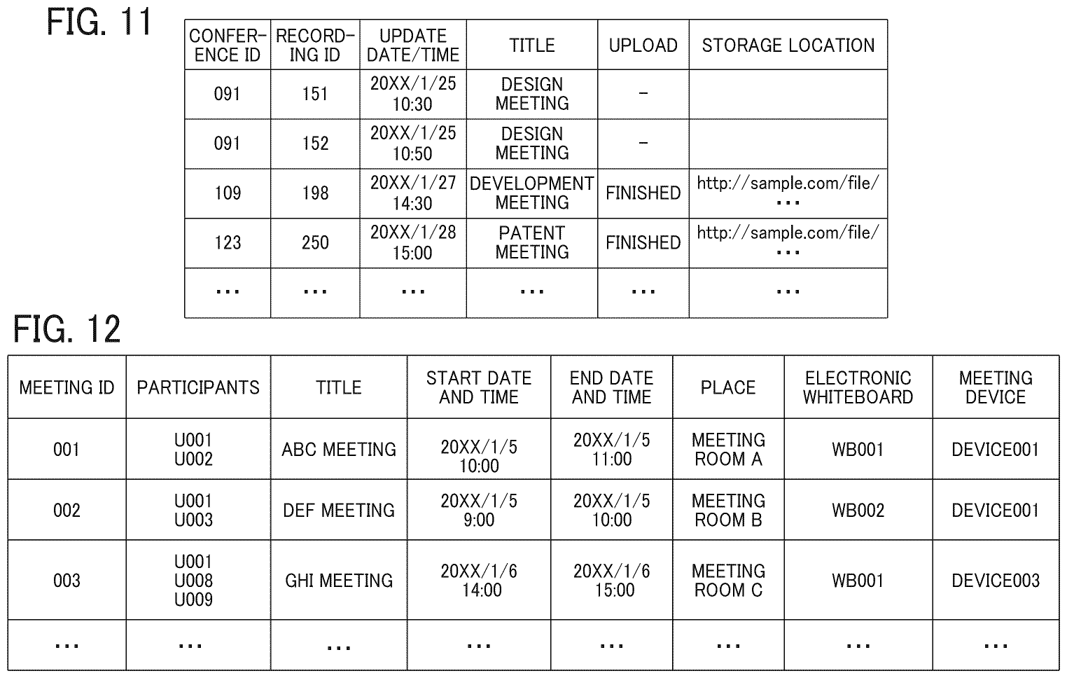

FIG. 11 illustrates example items of information on the recorded video, stored in the information storage area 1001. The information on the recorded video includes items such as “conference ID,” “recording ID,” “update date/time,” “title,” “upload,” and “storage location.” When a user logs into the information processing system 50, the information recording application 41 downloads conference information from a conference information storage area 5001 of the information processing system 50. The conference ID or the like included in the conference information is reflected in the information on the recorded video. The information on the recorded video in FIG. 11 is stored by the communication terminal 10 operated by a certain user.

The item “conference ID” is identification information identifying a held teleconference (communication identifier identifying a communication). The conference ID is assigned when a schedule of the teleconference is registered to a conference management system 9, or is assigned by the information processing system 50 in response to a request from the information recording application 41. The conference management system 9 is a system for registering conference and remote conference schedules, the URL (conference link) for starting a remote conference, reservation information for devices to be used in the conference, etc., and is a scheduler or the like connected from the terminal device 10 via a network. The conference management system 9 is also capable of transmitting the registered schedules, etc. to the information processing system 50.

The item “recording ID” is identification information identifying a combined video recorded during the teleconference. The recording ID is assigned by the meeting device 60, but may be assigned by the information recording application 41 or the information processing system 50. Different recording IDs are assigned to a same conference ID in a case where the recording is suspended in the middle of the teleconference but is started again for some reason.

The item “update date/time” represents the date and time when the combined video is updated (or recording is ended). When the combined video is edited, the update date and time is the date and time of editing.

The item “title” is a name of the conference. The title may be set when the conference is registered to the conference management system 9, or may be set by the user in any manner.

The item “uploaded” indicates whether the combined video has been uploaded to the information processing system 50.

The item “storage location” indicates a location, such as uniform resource locator (URL) or file path, where the combined video and the text data are stored in the storage service system 70. The item “storage location” allows the user to view the uploaded combined video as desired. Note that the combined video and the text data are stored with different file names following the URL, for example.

### Meeting Device

Referring back to FIG. 10, the description is continued. The meeting device 60 includes a terminal communication unit 61, a panoramic image generation unit 62 (acquisition unit), a talker image generation unit 63, a sound collection unit 64, and an audio synthesis unit 65. These functional units of the meeting device 60 are implemented by or caused to function by one or more of the components illustrated in FIG. 6 operating in accordance with instructions from the CPU 611 according to the control program loaded from the ROM 612 to the DRAM 614.

The terminal communication unit 61 communicates with the communication terminal 10 using a USB cable or the like. The connection of the terminal communication unit 61 to the communication terminal 10 is not limited to a wired cable, but includes connection by a wireless LAN, BLUETOOTH, or the like.

The panoramic image generation unit 62 generates a panoramic image. The talker image generation unit 63 generates a talker image. The method of generating a panoramic image and a talker image has been described with reference to FIGS. 7A to 8. The panoramic image generation unit 62 also serves as an acquisition unit that acquires image data.

The sound collection unit 64 converts sound received by the microphone of the meeting device 60 into audio data (digital data). Thus, the utterances (speeches) made by the user and the participants at the site where the communication terminal 10 is installed are collected.

The audio synthesis unit 65 combines the audio data transmitted from the communication terminal 10 and the sound collected by the sound collection unit 64. Accordingly, the speeches uttered at the second site 101 and those uttered at the first site 102 are combined.

### Information Processing System

The information processing system 50 illustrated in FIG. 10 includes a communication unit 51, an authentication unit 52, a screen generation unit 53, a communication management unit 54, a device management unit 55, and a text conversion unit 56. These functional unit of the information processing system 50 are implemented by or caused to function by one or more of the components illustrated in FIG. 5 operating in accordance with instructions from the CPU 501 according to the control program loaded from the HD 504 to the RAM 503. The information processing system 50 also includes a storage unit 5000 implemented by the HD 504 or the like illustrated in FIG. 5. The memory or storage unit 5000 includes the conference information storage area or memory 5001, a record information storage area or memory 5002, and an association storage area or memory 5003, each of which is implemented by a database, for example.

The communication unit 51 transmits and receives various kinds of information to and from the communication terminal 10. For example, the communication unit 51 transmits a list of teleconferences to the communication terminal 10, and receives a request of speech recognition on audio data from the communication terminal 10.

The authentication unit 52 authenticates a user who operates the communication terminal 10. For example, the authentication unit 52 authenticates a user based on whether authentication information (a user ID and a passcode) included in an authentication request received by the communication unit 51 matches authentication information held in advance. The authentication information may be a card number of an integrated circuit (IC) card, biometric authentication information of a face, a fingerprint, or the like. The authentication unit 52 may use an external authentication system or an authentication method such as Open Authorization (OAuth) to perform authentication.

The screen generation unit 53 generates screen information representing a screen to be displayed with a web application by the communication terminal 10. The screen information is described in Hyper Text Markup Language (HTML), Extended Markup Language (XML), Cascade Style Sheet (CSS), or JAVASCRIPT, for example.

The communication management unit 54 acquires information related to a teleconference from the conference management system 9 by using an account of each user or a system account assigned to the information processing system 50. The communication management unit 54 stores conference information of a scheduled conference in association with a conference ID in the conference information storage area 5001. The communication management unit 54 acquires conference information for which a user belonging to the tenant has a right to view. Since the conference ID is set for a conference, the teleconference and the record are associated with each other by the conference ID.

In response to receiving device IDs of the electronic whiteboard 2 and the meeting device 60 to be used in the conference, the device management unit 55 stores these device IDs, in association with the teleconference, in the association storage area 5003. Accordingly, the conference ID, the device ID of the electronic whiteboard 2, and the device ID of the meeting device 60 are associated with each other. Since the combined video is also associated with the conference ID, the hand-drafted data input on the electronic whiteboard 2 is also associated with the combined video. In response to the end of recording (the end of the conference), the device management unit 55 deletes the association from the association storage area 5003.

The text conversion unit 56 uses the external speech recognition service system 80 to convert, into text data, audio data requested to be converted into text data by the communication terminal 10. In some embodiments, the text conversion unit 56 may perform this conversion.

FIG. 12 illustrates an example of conference information stored in the conference information storage area 5001 and managed by the communication management unit 54. The communication management unit 54 uses the aforementioned account to acquire a list of teleconferences for which a user belonging to a tenant has a right to view. In the present embodiment, teleconferences are used as an example. However, the list of teleconferences also includes a conference held in a single conference room.

The conference information is managed with the conference ID, which is associated with the items “participant,” “title,” “start date and time,” “end date and time,” “place,” and the like. These items are an example of the conference information, and the conference information may include other information. Right to view may be granted to the conference information managed by the communication management unit 54 directly from the information recording application of the terminal device 10. In addition, teleconference information for which a user belonging to a tenant has right to view includes conference information generated by the user and conference information for which the user has been given right to view by another user.

The item “participant” represents participants of the conference.

The item “title” represents a content of the conference such as a name of the conference or an agenda of the conference.

The item “start date and time” indicates a date and time at which the conference is scheduled to be started.

The item “end date and time” indicates a date and time at which the conference is scheduled to end.

The item “place” represents a place where the conference is held such as a name of a conference room, a name of a branch office, or a name of a building.

The item “electronic whiteboard” represents a device ID of the electronic whiteboard 2 used in the conference.

The item “meeting device” indicates identification information of the meeting device 60 used in the conference.

As illustrated in FIGS. 11 and 112, a combined video recorded at a conference is identified by the conference ID.

The information on the recorded video stored in the record information storage area 5002 may be the same as the information illustrated in FIG. 10. However, the information processing system 50 has a list of combined videos recorded by all users belonging to the tenant. The user may input desired storage destination information (path information such as URL of a cloud storage system) on a user setting screen of the information recording application 41 of the terminal device 10 and store the information in the recording information storage unit 5002.

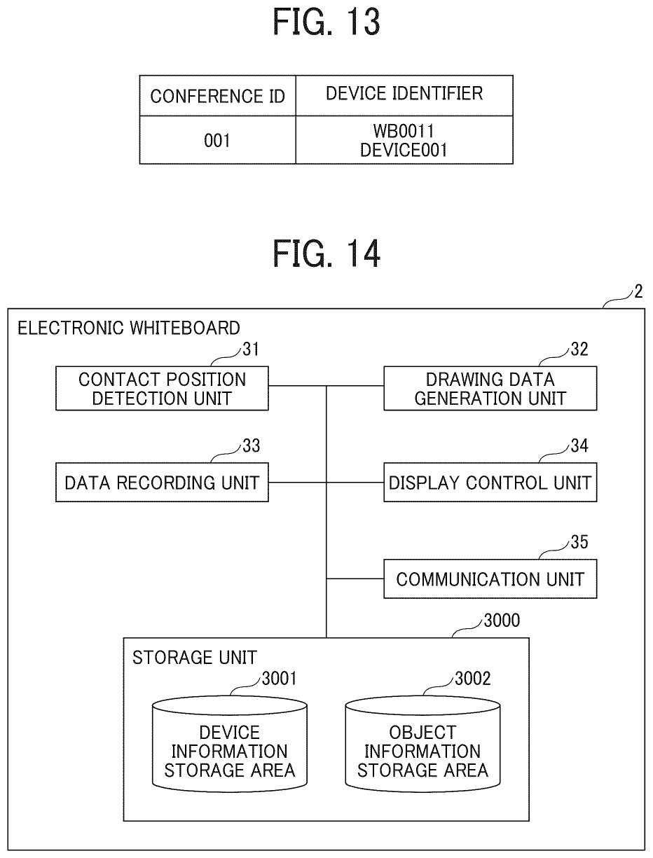

FIG. 13 illustrates an example of association information associating a conference ID with the device IDs of the electronic whiteboard 2 and the meeting device 60. The association information is stored in the association storage area 5003. The association information is held from when the information recording application 41 transmits the device ID to the information processing system 50 to when the recording ends. This association information is maintained from the time the participant joins the conference until the conference ends (leaves the room).

### Electronic Whiteboard

FIG. 14 is a block diagram illustrating a functional configuration of the electronic whiteboard 2 according to the present embodiment. The electronic whiteboard 2 includes a contact position detection unit 31, a drawing data generation unit 32, a data recording unit 33, a display control unit 34, and a communication unit 35. The respective functions of the electronic whiteboard 2 are functions or means that are implemented by one or more of the components illustrated in FIG. 9 obeying instructions from the SSD 404 according to a program loaded to the RAM 403 from the CPU 401.

The contact position detection unit 31 detects coordinates of a position where the electronic pen 490 has touched the contact sensor 414. The drawing data generation unit 32 acquires the coordinates of the position touched by the tip of the electronic pen 490 from the contact position detection unit 31. The drawing data generation unit 32 interpolates a sequence of coordinate points and links the resulting coordinate points to generate stroke data.

The display control unit 34 displays hand-drafted data, character string converted from hand-drafted data, a menu to be operated by the user, and the like on the display.

The data recording unit 33 stores, in an object information storage area 3002, information on hand-drafted data hand-drawn on the electronic whiteboard 2, hand-drafted data converted into shapes such as a circle or triangle, a stamp of “DONE” or the like, a PC screen, and a file. Each of the hand-drafted data, the graphic, the image such as a PC screen, and the file is treated as an object. Regarding handwritten data, a set of stroke data grouped is stored as one object. Grouping is made by time due to interruption of input of handwriting or by the position where the handwriting is input.

The communication unit 35 is connected to Wi-Fi or a LAN and communicates with the information processing system 50. The communication unit 36 transmits object information to the information processing system 50, receives object information stored in the information processing system 50 from the information processing system 50, and displays object based on the object information on the display 480.

The electronic whiteboard 2 also includes a storage unit 3000 implemented by the SSD 404 or the like illustrated in FIG. 8. The storage unit 3000 includes the device information storage area 3001 and the object information storage area 3002 each of which is implemented by a database, for example.

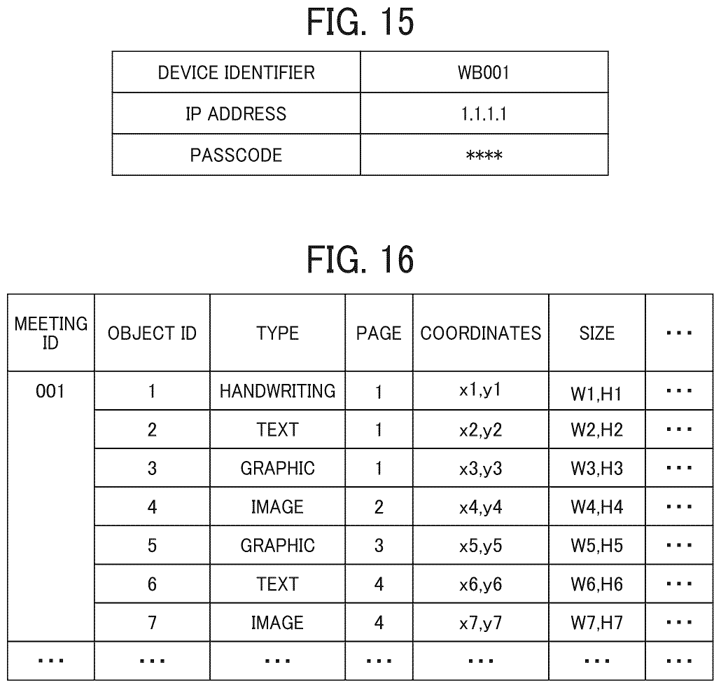

FIG. 15 illustrates information such as a device identifier or ID stored in the device information storage area 3001. The item “device identifier” or ID is identification information identifying the electronic whiteboard 2.

The item “Internet Protocol (IP) address” is used by another device to connect to the electronic whiteboard 2 via a network.

The item “passcode” is used for authentication performed when another apparatus connects to the electronic whiteboard 2.

FIG. 16 illustrates an example of object information stored in the object information storage area 3002 according to the present embodiment. The object information is information for managing an object displayed by the electronic whiteboard 2. The object information is transmitted to the information processing system 50 and is used as minutes.

In a case where the electronic whiteboard 2 is located at the second site when the teleconference is held, the object information is shared with the first site.

The item “conference ID” indicates identification information of a conference notified from the information processing system 50.

The item “object ID” indicates identification information for identifying an object.

The item “type” indicates a type of the object. the type of object includes, for example, handwriting, text, graphic, and image. “Handwriting” represents stroke data (coordinate point sequence). “Text” represents a character string (character codes) input from a software keyboard. The character string may also be referred to as text data. “Graphic” is a geometric shape such as a triangle or a quadrangle. “Image” represents image data in a format such as Joint Photographic Experts Group (JPEG), Portable Network Graphics (PNG), or Tagged Image File Format (TIFF) acquired from, for example, a PC or the Internet.

A single screen of the electronic whiteboard 2 is referred to as a page. A “page” indicates the page number.

The item “coordinates” indicate a position of an object relative to a predetermined origin on the electronic whiteboard 2. The position of the object is, for example, the upper left vertex of a circumscribed rectangle of the object. The coordinates are expressed, for example, in units of pixels of the display.

The item “size” indicates a width and a height of the circumscribed rectangle of the object.

### Image Processing System

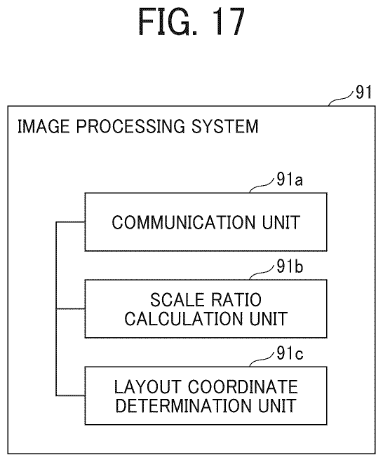

FIG. 17 is a functional block diagram explaining the functions of image processing system 91 by dividing them into blocks. Image processing system 91 has a communication unit 91a, a magnification/reduction ratio calculation unit 91b, and a layout coordinate determination unit 91c. Each function of image processing system 91 is a function or means realized when any of the components shown in FIG. 5 operates in response to an instruction from CPU 501 in accordance with a program loaded from HD 504 onto RAM 503.

The image processing system 91 can be implemented using a plug-in program or an add-in program, along with appropriate hardware including a processor or circuitry, that can be called by the teleconference service system 90. Therefore, the image processing system 91 and the teleconference service system 90 appear as a single unit to the teleconference application 42. However, the image processing system 91 may exist independently of the teleconference service system 90, or the functions of the image processing system 91 may be incorporated into the teleconference service system 90.

In response to a call from the teleconference service system 90, the communication unit 91a receives from the teleconference service system 90 the subject size, image size, etc. of each image to be adjusted (panorama images 301, 302, image 303). The communication unit 91a may receive each image itself. In addition, the communication unit 91a transmits to the teleconference service system 90 the scale ratios of each enlargement calculated so that the subject sizes are approximately the same, and the layout coordinates of each image on the conference screen.

The scale ratio calculation unit 91b calculates the scale ratio for enlarging/reducing each image so that the subject size of each image is approximately the same. In other words, the scale ratio calculation unit 91b calculates an scale ratio for an image whose subject size is smaller than the average subject size, and calculates a reduction scale ratio for an image whose subject size is larger than the average subject size.

The layout coordinate determination unit 91c determines the layout of each image on the conference screen displayed by the terminal device 10. The layout coordinate determination unit 91c further resizes each image as necessary.

### Image Scaling

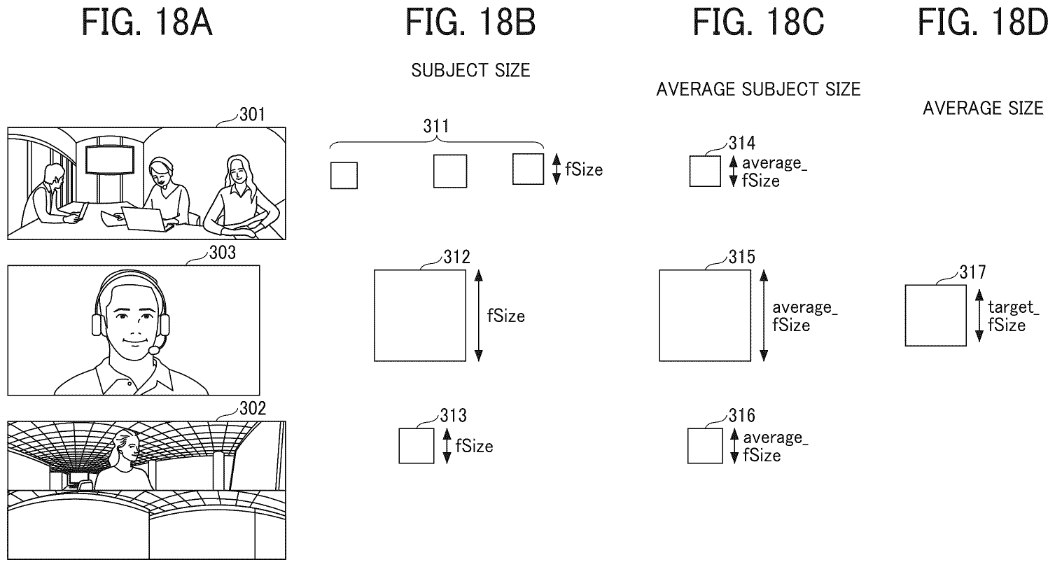

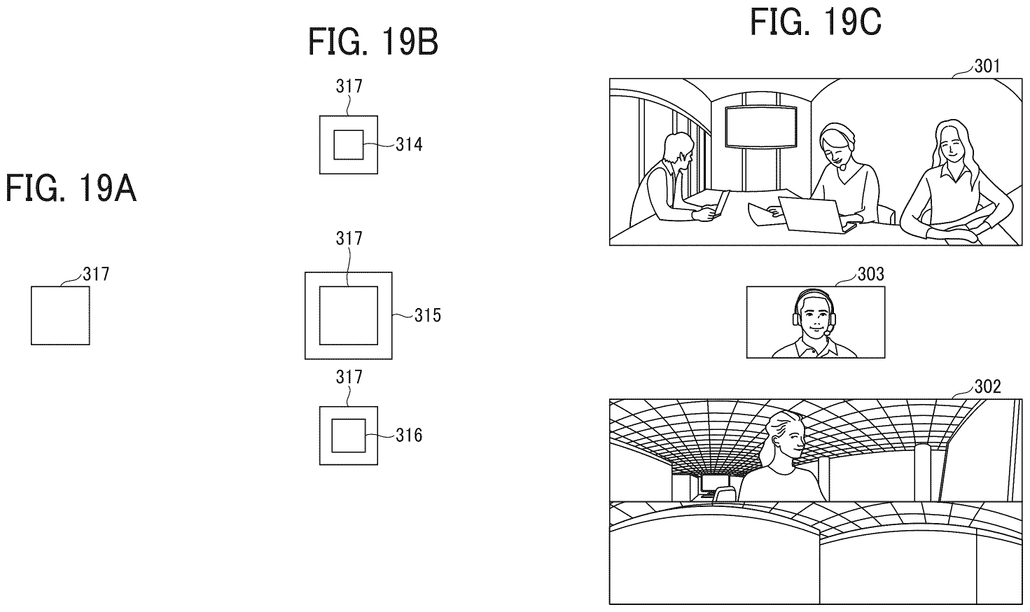

Next, a method for calculating the scale ratio will be described with reference to FIGS. 18A-18D and FIGS. 19A-19C. FIGS. 18A-18D are diagrams for explaining the average subject size and the average size. FIG. 18A shows three images (panoramic images 301, 302, and image 303) displayed by terminal device 10. The size of the subject (e.g., a person's face) in each of these images varies depending on the camera performance, the angle of view, the distance to the person, etc.

For this reason, the scale ratio calculation unit 91b performs the following process. Note that the following process is executed when a participant is added to the conference (when the teleconference service system 90 notifies the image processing system 91).

First, the scale ratio calculation unit 91b obtains position information of the subject appearing in each image from the teleconference service system 90. When the image processing system 91 obtains the image itself from the teleconference service system 90, the scale ratio calculation unit 91b recognizes the subject. A known example of this type of image processing is a method that uses a model for recognizing faces using a Convolutional Neural Network. FIG. 18B shows face images recognized from three images. Face image 311 was extracted from panoramic image 301, face image 312 was extracted from image 303, and face image 313 was extracted from panoramic image 302. The scale ratio calculation unit 91b extracts circumscribing rectangles of the faces from panoramic images 301, 302, and image 303, and sets the number of pixels in the height and width of the circumscribing rectangle (here, a square) as the subject size (fSize).

Next, when multiple subjects are detected from one image (panoramic images 301, 302, image 303), the scale ratio calculation unit 91b calculates the average subject size for each image (hereinafter referred to as average subject size (average_fSize)). This is because the subject sizes may vary even within a single image. In FIG. 18B, three subjects are captured in panoramic image 301, so the scale ratio calculation unit 91b calculates the average of the three face images 311 as the average subject size (average_fSize). Rectangles 314 to 316 in FIG. 18C diagrammatically show the average subject size. The average subject size of rectangles 315 and 316 is the same as the subject size of image 303 and panoramic image 302.

Next, the scale ratio calculation unit 91b uses the three average subject sizes (average_fSize) to further calculate their average size (target_fSize). As a result, one average size (target_fSize) is obtained, as shown in FIG. 18D. A rectangle 317 in FIG. 18D shows a schematic representation of the average size.

FIGS. 19A-19C are diagrams illustrating the process of enlarging or reducing an image based on the average size. The scale ratio calculation unit 91b calculates the scale ratio at which the average subject size (average_fSize) in the image becomes the average size (target_fSize). FIG. 19A shows the average size (target_fSize) as a rectangle 317. FIG. 19B shows a comparison of the average subject size (average_fSize) and the average size (target_fSize) by overlaying rectangles 317 and 314, rectangles 317 and 315, and rectangles 317 and 316. As shown in FIG. 19B, the scale ratio calculation unit 91b calculates the scale ratio=target_fSize/average_fSize, which is the size ratio between rectangles 317 and 314, rectangles 317 and 315, and rectangles 317 and 316.

The teleconference service system 90 then multiplies the image size by the scale ratio. For example, the average subject size (average_fSize)=width: 2 height: 5, the average size (target_fSize)=width: 10 height: 5.

$$\begin{matrix}Scale ratio width = 10 / 2 = 5 \\ Scale ratio height = 5 / 5 = 1\end{matrix}$$

The teleconference service system 90 therefore multiplies the image size by 5 times in the width direction and 1 time in the height direction. Note that if the width and height scale ratios are different, the aspect ratio will change, so the width and height may be enlarged or reduced by the larger of the width and height scale ratios. FIG. 19C shows panoramic images 301, 302, and image 303 enlarged or reduced by the scale ratio. It can be seen that the subject sizes are more consistent in the image in FIG. 19C than in FIG. 18A.

### Image Placement

Next, the layout coordinates of each image will be explained. The layout coordinate determination unit 91c determines the layout coordinates for placing each image with its image size adjusted on one conference screen. In other words, it determines the layout coordinates for displaying a list of images with their image size adjusted on the conference screen displayed by the teleconference app 42 during the conference. The placement based on the layout coordinates is performed by the teleconference service system 90.

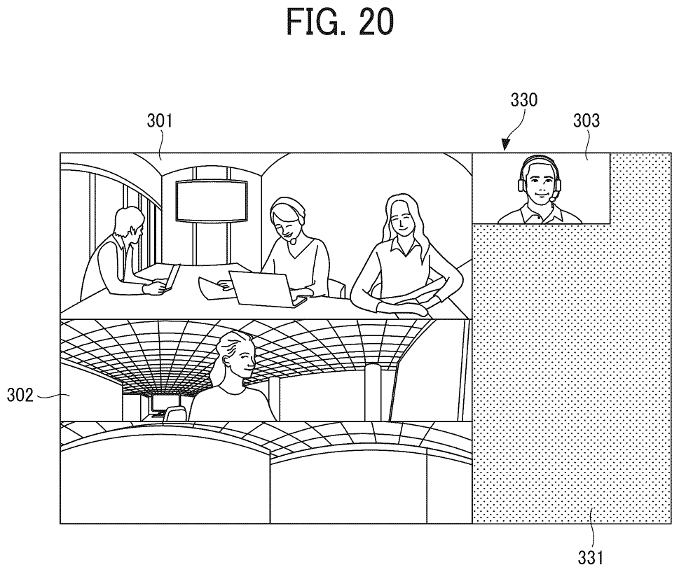

FIG. 20 shows a conference screen 330 that the teleconference app 42 displays during a conference. The conference screen 330 in FIG. 20 is a screen that displays a or plurality of images from each location. In addition to the conference screen in FIG. 20, there may be a screen on which an image of a specific location, such as a person speaking, is displayed large and the images of the remaining locations are displayed small, or a screen on which documents are displayed large and the images of the locations are displayed small, etc.

The conference screen 330 has an image display area 331. When displaying the conference screen 330 of FIG. 20, the layout coordinate determination unit 91c arranges the images, for example, from the upper left (the edge of the conference screen) to the lower right of the display area 331. The images may be arranged in the order in which they joined the conference, for example. The user may be able to change the order of arrangement as desired.

The number of images to be arranged in a row is a fixed value determined in advance. In FIG. 20, the fixed value is 2, and two images are arranged in a row. The fixed value may be the minimum number of images to be arranged in a row (at least this number of images are arranged vertically). For example, if more than two images can be arranged vertically in terms of size, three or more images may be arranged vertically. This allows the display area to be used effectively. In the example of FIG. 20, the layout coordinate determination unit 91c was able to arrange two panoramic images 301 and 302 in one row, but when image 303 is arranged, it will exceed the height of the display area. For this reason, the layout coordinate determination unit 91c arranges image 303 at the top of the second row. If the widths of the images in the first row do not match, the images in the second row are arranged so as not to overlap with the widest image in the first row.

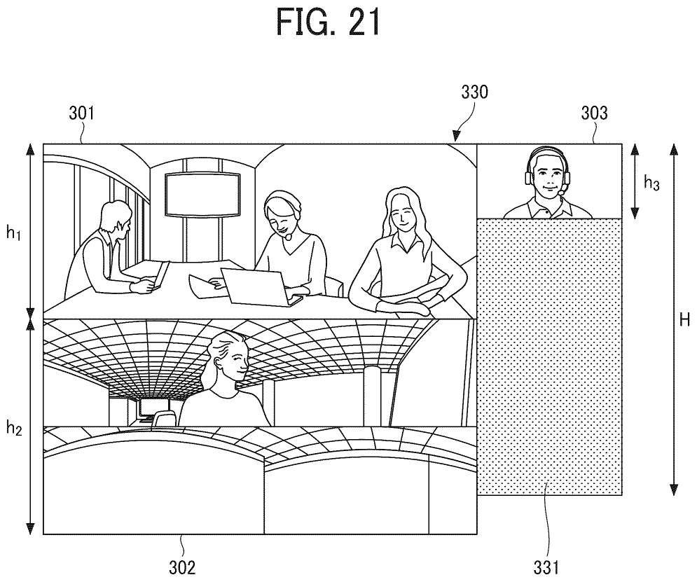

Also, as shown in FIG. 21, if the number of images arranged in the display area 331 of the conference screen 330 exceeds the display area 331 even if the number of images is less than a fixed value, the layout coordinate determination unit 91c resizes all images at the same reduction ratio so that they fit within the display area.

The vertical length of display area 331 is shorter than the sum of the vertical lengths of panoramic images 301, 302. In this case, the layout coordinate determination unit 91c resizes (reduces) all images at the same ratio as follows.

Let H be the number of vertical pixels of display area 331.

Let h1 be the number of vertical pixels of panoramic image 301.

Let h2 be the number of vertical pixels of panoramic image 302.

Let h3 be the number of vertical pixels of image 303.

H<h1+h2.

Since we wish to arrange the panoramic images 301 and 302 vertically, the reduction ratio R is as follows:

$$R = H / ( h 1 + h 2 )$$

The layout coordinate determination unit 91c resizes the horizontal and vertical lengths of all images by the reduction ratio R. The horizontal length is also reduced in order to maintain the aspect ratio. As a result, the vertical length of panoramic image 301 becomes h1×R, the vertical length of panoramic image 302 becomes h2×R, and the vertical length of image 303 becomes h3×R. Even with resizing in this way, the subject size in each video remains approximately the same.

FIG. 21 describes the case where the vertical length of display area 331 is shorter than the sum of the vertical lengths of the two images, but the same applies to the case where the horizontal length of display area 331 is shorter than the sum of the horizontal lengths of the two images. Either the vertical or horizontal reduction can be performed first. For example, if resizing is performed based on the vertical length but the horizontal length of display area 331 is insufficient, the layout coordinate determination unit 91c calculates the reduction rate R so that the horizontal lengths of panoramic image 301 and image 303 fit within the width of display area 331.

### Regarding Processing or Operation

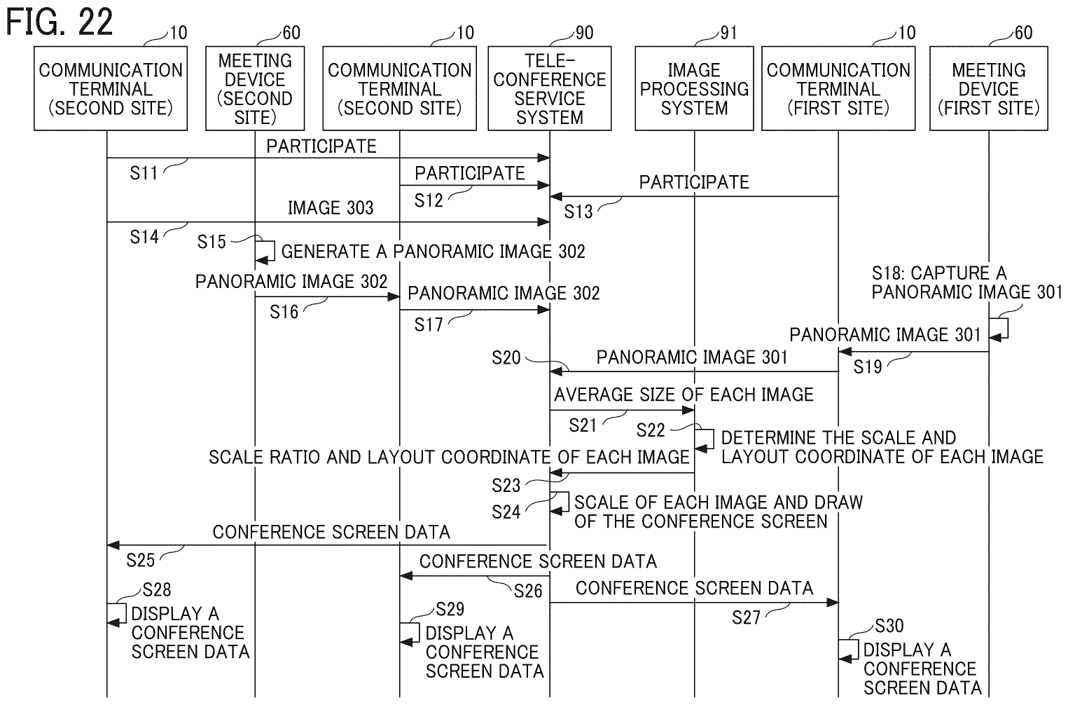

Next, the flow of image data and changes in image size during a remote conference will be described with reference to FIG. 22. FIG. 22 is a sequence diagram that explains the process in which a terminal device 10 at a first site displays enlarged or reduced images of each base during a teleconference. Note that audio data is also transmitted along with the image data, but the transmission of the audio data is omitted in the figure, although it can be considered, if desired that the transmission of image data also includes audio data.

S11 to S13: Participants at each location operate the terminal device 10 to connect the terminal device 10 to the teleconference service system 90. Participants specify the conference ID and passcode that have been distributed in advance by email or the like, and perform operations to participate in the conference. As a result, each terminal device 10 participates in the same conference.

S14: The terminal device 10 at the second site 101B captures an image of the participants with the built-in camera, and the teleconference application 42 transmits the image 303 with the normal angle of view to the remote conference service system 90.

S15: The panoramic image creation unit 62 of the meeting device 60 at the second site 101A captures the surroundings and generates a panoramic image 302. The talker image creation unit 63 generates a talker image from the panoramic image 302, but this is omitted from the diagram.

S16: The terminal communication unit 61 of the meeting device 60 at the second site 101A transmits the panoramic image 302 to the terminal device 10.

S17: The device communication unit 16 of the terminal device 10 at the second site 101A receives the panoramic image 302. The image and audio transmission unit 23 passes the panoramic image 302 to the teleconference application 42. The teleconference application 42 transmits the panoramic image 302 to the teleconference service system 90.

S18: The panoramic image creation unit 62 of the meeting device 60 at the first site 102 captures the surroundings and generates a panoramic image 301. The talker image creation unit 63 generates a talker image from the panoramic image 301, but this is omitted from the diagram.

S19: The terminal communication unit 61 of the meeting device 60 at the first site 102 transmits the panoramic image 301 to the terminal device 10.

S20: The device communication unit 16 of the terminal device 10 at the first site 102 receives the panoramic image 301. The image and audio transmission unit 23 passes the panoramic image 301 to the teleconference application 42. The teleconference application 42 transmits the panoramic image 301 to the remote conference service system 90.

S21: The teleconference service system 90 calls the image processing system 91 and transmits the image sizes of the panoramic images 301, 302, and image 303 to the image processing system 91. At this time, the teleconference service system 90 also transmits the coordinates of the subject (for example, the coordinates of a rectangle including a face) to the image processing system 91. Alternatively, the teleconference service system 90 transmits the panoramic images 301, 302, and image 303 to the image processing system 91, and the image processing system 91 detects the coordinates of the subject.

S22: Communication unit 91a of image processing system 91 receives the image sizes and subject coordinates of panoramic images 301, 302, and image 303. The subject size can also be determined from the subject coordinates. Scaling ratio calculation unit 91b of image processing system 91 calculates the scaling ratios for each image that will result in approximately the same subject size for each image, and also determines the layout coordinates on the conference screen. Details of this process will be described later.

S23: The communication unit 91a of the image processing system 91 transmits to the teleconference service system 90 each scale ratio and layout coordinates that result in approximately the same subject size.

S24: The teleconference service system 90 enlarges or reduces each image at the enlargement or reduction ratio of each image, and draws the conference screen. Drawing means creating conference screen.

S25 to S27: The teleconference service system 90 transmits the conference screen information to the terminal device 10 at each site.

S28 to S30: The teleconference application 42 of the terminal device 10 receives the conference screen and displays the conference screen.

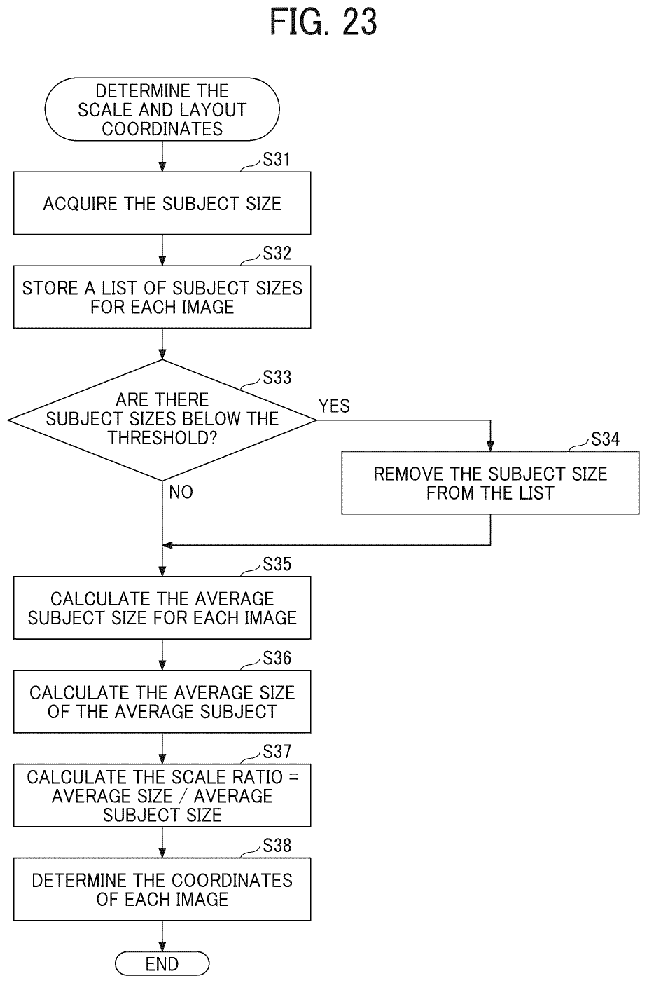

FIG. 23 is an example of a flowchart illustrating the process in step S22 in which the image processing system 91 calculates the scale ratio of each image and determines the layout coordinates of each image.

First, the scale ratio calculation unit 91b acquires the subject size (face size) (S31). If the teleconference service system 90 has a function for recognizing faces, the scale ratio calculation unit 91b can acquire the subject size from the teleconference service system 90. The scale ratio calculation unit 91b may perform face recognition from each image to acquire the subject size.

Next, the scale ratio calculation unit 91b saves a list of subject sizes for each image (panoramic images 301, 302, and image 303) (S32). In other words, the scale ratio calculation unit 91b lists the subject sizes within the same image.

Next, the scaling ratio calculation unit 91b determines whether there is a subject size that is below the threshold (S33). If the determination in step S33 is Yes, the scaling ratio calculation unit 91b removes the subject size from the list (S34). In this way, even if there is a subject size that is too small, it is possible to prevent this from causing the subject sizes of other images to become smaller. If all subject sizes in an image are below the threshold, the scaling ratio is not calculated for this image (average subject size is not calculated) and no scaling is performed.

Next, the scale ratio calculation unit 91b calculates the average of the listed subject sizes (average subject size) for each image (S35).

Next, the scale ratio calculation unit 91b calculates an average size, which is an average of the average subject sizes (S36).

Next, the scale ratio calculation unit 91b calculates the scale ratio (=average size/average subject size) (S37).

Next, the layout coordinate determination unit 91c determines the layout coordinates of each image (S38). That is, the layout coordinate determination unit 91c arranges the panoramic images 301, 302, and image 303 vertically from the top left of the display area of the conference screen. If it is not possible to arrange one column of images of fixed sizes, the layout coordinate determination unit 91c resizes the panoramic images 301, 302, and image 303 at the same ratio.

Since the teleconference service system 90 enlarges or reduces each image at the enlargement or reduction ratio determined as described above, even if the subject sizes in the images transmitted by each base station are different, the subject sizes in each image displayed by the terminal device 10 can be made approximately the same.

### Manual Setting of Average Size

In addition to the scale ratio calculation unit 91b calculating the average size, the user may specify the average size. For example, if the facial images of all the participants are small, the calculated average size will also be small. In such a case, the user can manually specify the average size to enlarge each image to a size that makes it easy to see everyone's expressions.

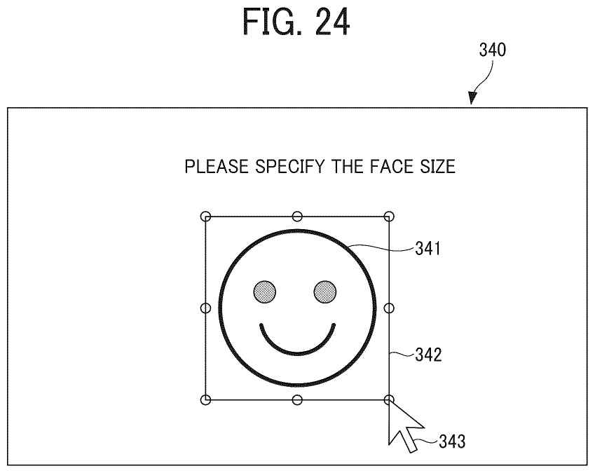

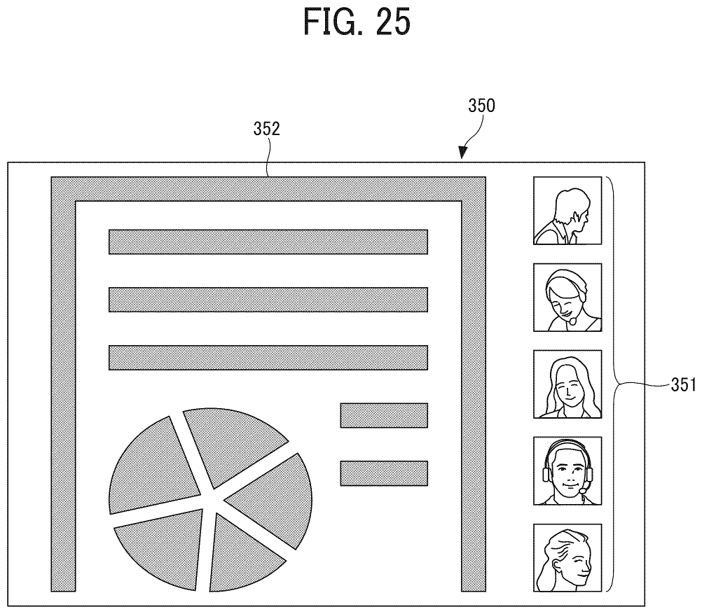

FIG. 24 shows an average size setting screen 340 displayed by terminal device 10. The average size setting screen 340 has a face model 341 and a frame 342 surrounding the face model. The user can specify the average size by dragging frame 342 with mouse pointer 343. As the user drags, the size of the face model 341 increases or decreases in tandem. If the user drags a corner of frame 342, the average size can be adjusted while maintaining the aspect ratio, and if the user drags a side of frame 342, the average size can be adjusted to any aspect ratio.

Note that the user can manually set the average size for a touch panel as well. For example, the user can specify the average size by long-pressing frame 342 (a corner or side) and then swiping. The user may also set the average size numerically. In this case, the user can set at least one of the width and height of the average size by length or number of pixels.

Note that if the average size is manually input, the average size is notified to the teleconference service system 90 from the teleconference app 42 of the terminal device 10. The teleconference service system 90 notifies the image processing system 91 of the manually input average size and that it will be used to calculate the scale ratio. In this case, in the flowchart of FIG. 23, since the average size has already been calculated, the processing of step S36 (calculation of the average size) is skipped.

If the average size is manually input, the terminal device 10 of the user who manually input the average size displays the image scaled at the generate calculated from the manually input average size and average subject size. The terminal devices 10 of the other users display the image scaled at the generate calculated from the average size and average subject size calculated in the processing of step S36. However, the terminal devices 10 of all users may display the image scaled at the generate calculated from the manually input average size and average subject size.

### Image Display in Document Display Mode

The conference screen has a material display mode in which the material screen is displayed larger. In the material display mode, each image is displayed small, so even if the image is enlarged or reduced so that the subject size is approximately the same, the subject size will be smaller. Therefore, the scale ratio calculation unit 91b can notify the teleconference service system 90 of the coordinates of a circumscribing rectangle for trimming the subject in the material display mode.

FIG. 25 shows a document display mode screen 350 that displays a subject image 351 in document display mode. Multiple subject images 351 and document images 352 are displayed on the document display mode screen 350. Subject image 351 is a circumscribing rectangle of the subject that has been trimmed from each image whose size has been adjusted so that the subject sizes are approximately the same. Because the portion of subject image 351 that includes the face has been extracted, it can be displayed relatively large even when placed on the document display mode screen 350.

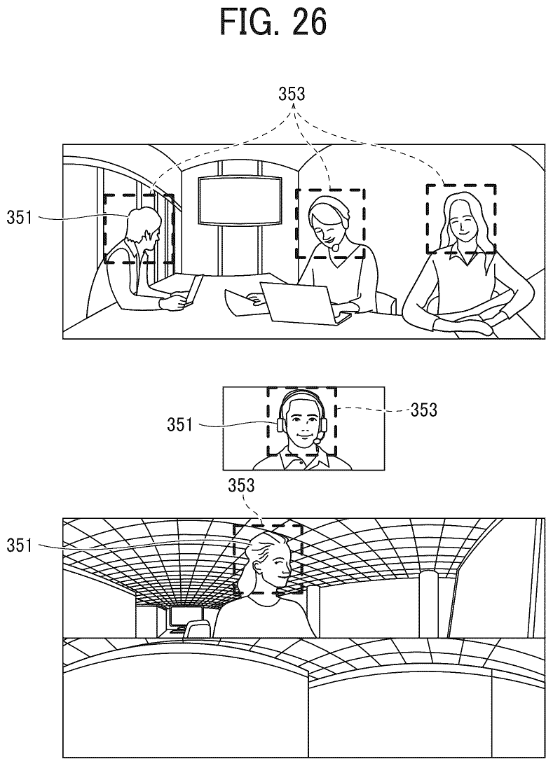

FIG. 26 is a diagram illustrating a subject image 351 that is cropped from each image whose size has been adjusted so that the subject sizes are approximately the same. Note that the panoramic images 301, 302 and image 303 in FIG. 26 are the same as those in FIG. 19C (already enlarged or reduced). In FIG. 26, the cropped range is indicated by a dotted frame 353. By the teleconference service system 90 performing cropping in this manner, the terminal device 10 can display the faces of the participants together with the document image 352 with the subject sizes of each image being approximately the same.

Pattern matching and machine learning (AI) are used to recognize face images. In pattern matching, the teleconference service system 90 (or the image processing system 91) slides a window and searches all areas of the image with the window. Identification processing is performed on the faces in each window using pattern matching to determine whether they are faces. In one example of machine learning (AI), the teleconference service system 90 (or the image processing system 91) detects all areas that are likely to be objects using the Region proposal method, and inputs each area into a convolutional network to determine whether it is the target object (face). There is also a known algorithm called YOLO (You Only Look Once), which simultaneously detects and identifies objects.

When a participant operates to switch to the document display mode, the terminal device 10 notifies the remote conference service system 90, and the remote conference service system 90 notifies the image processing system 91 that the conference screen is in the document display mode.

If the teleconference service system 90 supports the trimming process as shown in FIG. 26, the scale ratio calculation unit 91b requests the teleconference service system 90 to trim the subject image 351. The teleconference service system 90 is notified of the scale ratio, and trims the subject image 351 from each image after scale. If the teleconference service system 90 does not support trimming, the scale ratio calculation unit 91b only needs to obtain each image from the teleconference service system 90, enlarge or reduce each image, and trim the subject image 351 from each image after scale.

### Recording During Conference

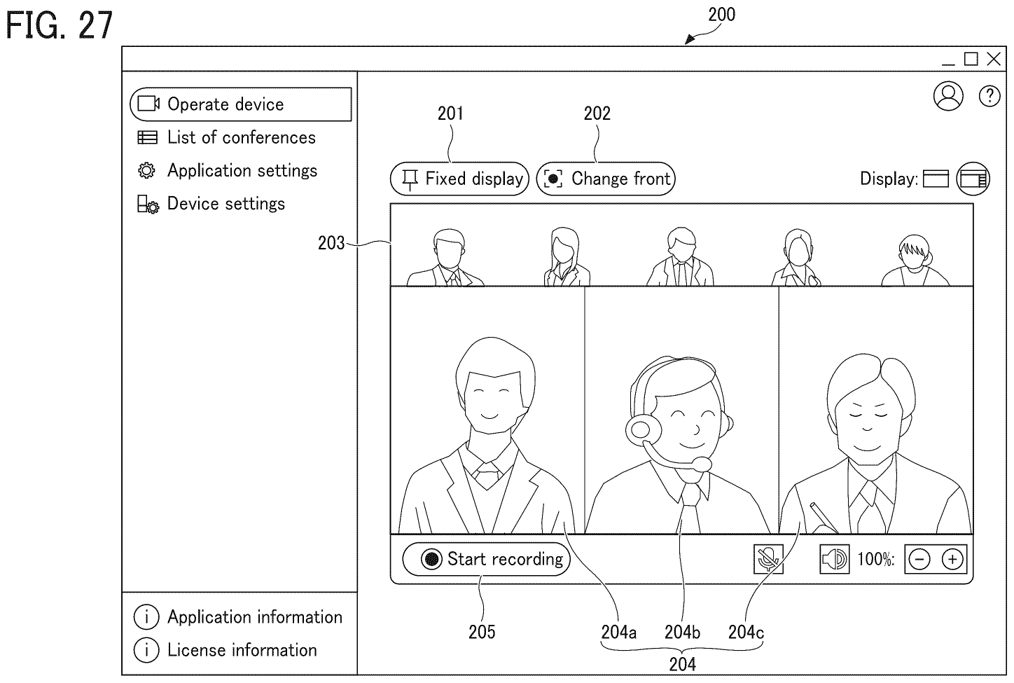

Descriptions are now given of several screens displayed by the communication terminal 10 in a teleconference, with reference to FIGS. 27 to 30. FIG. 27 is a diagram illustrating an example of an initial screen 200 displayed by the information recording application 41 operating on the communication terminal 10 after a login. The user of the communication terminal 10 connects to the information processing system 50 on the information recording application 41. The user inputs authentication information, and when the login is successful, the initial screen 200 of FIG. 16 is displayed.

The initial screen 200 includes a fixed display button 201, a change front button 202, the panoramic image 203, one or more talker images 204a to 204c, and a start recording button 205. In the following description, each of the talker images 204a to 204c may be simply referred to as a “talker image 204,” when not distinguished from each other. In a case where the meeting device 60 has already been started and is capturing an image of the surroundings at the time of the login, the panoramic image 203 and the talker images 204 generated by the meeting device 60 are displayed on the initial screen 200. This allows the user to decide whether to start recording while viewing the panoramic image 203 and the talker images 204. In a case where the meeting device 60 is not started (is not capturing any image), the panoramic image 203 and the talker images 204 are not displayed.

The information recording application 41 may display the talker images 204 of all participants based on all faces detected from the panoramic image 203, or may display the talker images 204 of certain number (N) of persons who have made an utterance most recently. In the example illustrated in FIG. 16, the talker images 204 of up to three persons are displayed. Display of the talker image 204 of a participant may be omitted until one of the participants makes an utterance (in this case, the number of the talker images 204 increases by one in response to an utterance). Alternatively, the talker images 204 of three participants in a predetermined direction may be displayed (the talker images 204 are switched in response to an utterance).

When no participant is speaking such as immediately after the meeting device 60 is turned on, an image of a predetermined direction (such as 0 degrees, 120 degrees, or 240 degrees) of 360 degrees in the horizontal direction is generated as the talker image 204. When fixed display (described later) is set, the setting of the fixed display is prioritized.

The fixed display button 201 is a button for the user to perform an operation of fixing a certain area of the panoramic image 203 as the talker image 204 in close-up.

The change front button 202 is a button for the user to perform an operation of changing the front of the panoramic image 203. Since the panoramic image presents the 360-degree surroundings in the horizontal direction, the right end and the left end matches to the same direction. The user slides the panoramic image 203 leftward or rightward with a pointing device to set a particular participant to the front. The user's operation is transmitted to the meeting device 60. The meeting device 60 changes the angle set as the front in 360 degrees in the horizontal direction, generates the panoramic image 203, and transmits the panoramic image 203 to the communication terminal 10.

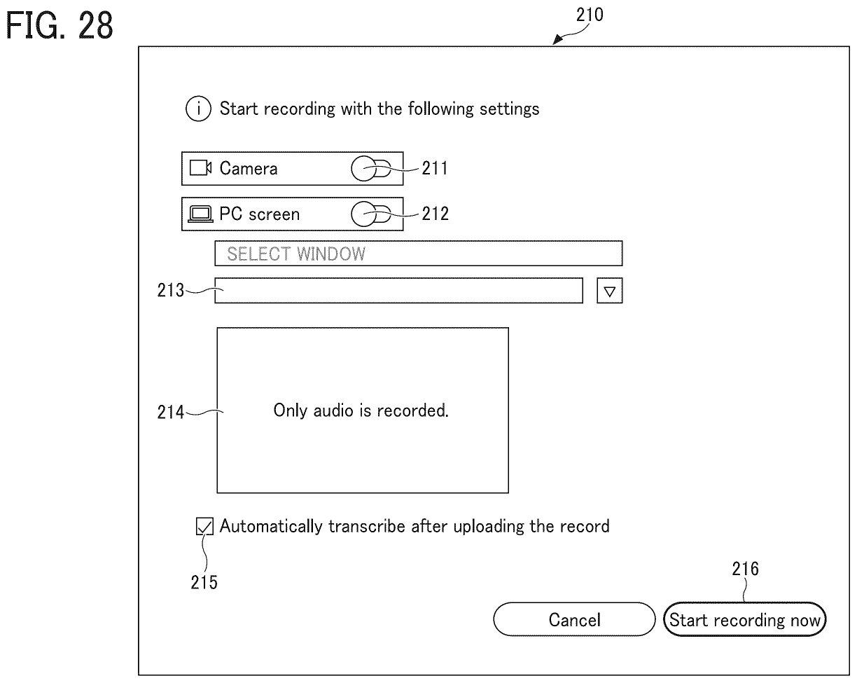

When the user presses the start recording button 205, the information recording application 41 displays a recording setting screen 210 illustrated in FIG. 28.

FIG. 28 is a diagram illustrating an example of the recording setting screen 210 displayed by the information recording application 41. The recording setting screen 210 allows the user to set whether to record (whether to include in a recorded video) the panoramic image 203 and the talker images 204 generated by the meeting device 60 and the desktop screen of the communication terminal 10 or the screen of the application operating on the communication terminal 10. In a case where the information recording application 41 is set to record none of the panoramic image, the talker image, and the desktop screen or the screen of the operating application, the information recording application 41 records only audio (audio output by the communication terminal 10 and audio collected by the meeting device 60).

A camera toggle button 211 is a button for switching on and off of recording of the panoramic image and the talker image generated by the meeting device 60. Alternatively, the camera toggle button 211 may allow settings for switching on and off of recording of the panoramic image and the talker image individually.

A PC screen toggle button 212 is a button for switching on and off of recording of the desktop screen of the communication terminal 10 or a screen of an application operating on the communication terminal 10. When the PC screen toggle button 212 is on, the desktop screen is recorded.

When the user desires to record the screen of the application, the user further selects the application in an application selection field 213. In the application selection field 213, names of applications operating on the communication terminal 10 are displayed in a pull-down format. Thus, the application selection field 213 allows the user to select an application whose screen is to be recorded. The information recording application 41 acquires the names of the applications from the OS. The information recording application 41 can display names of applications that have a user interface (UI) (screen) among applications being executed. The applications to be selected may include the teleconference application 42. Thus, the information recording application 41 can record a material displayed by the teleconference application 42, the participant at each site, and the like as a video. In addition, various applications such as a presentation application, a word processor application, a spreadsheet application, and a Web browser application are displayed in a pull-down manner. This thus allows the user to flexibly select the screen of the application to be included in the combined video.

When recording is performed in units of applications, the user is allowed to select a plurality of applications. The information recording application 41 can record the screens of all the selected applications.

When both the camera toggle button 211 and the PC screen toggle button 212 are set to off, a message “Only audio is recorded” is displayed in a recorded content confirmation window 214. The audio in this case includes audio output from the communication terminal 10 (audio received by the teleconference application 42 from the second site 101) and audio collected by the meeting device 60. That is, when a teleconference is being held, the audio from the teleconference application 42 and the audio from the meeting device 60 are stored regardless of whether the images are recorded. Note that the user may make a setting to selectively stop storing the sound from the teleconference application 42 and the sound from the meeting device 60 according to user settings.

In accordance with a combination of on and off of the camera toggle button 211 and the PC screen toggle button 212, a combined video is recorded in the following manner. The combined video is displayed in real time in the recorded content confirmation window 214.

In a case where the camera toggle button 211 is on and the PC screen toggle button 212 is off, the panoramic image and the talker images generated by the meeting device 60 are displayed in the recorded content confirmation window 214.

If the camera toggle button 211 is off and the PC screen toggle button 212 is on (and the screen has also been selected), the desktop screen or the screen of the selected application is displayed in the recorded content confirmation window 214.

In a case where the camera toggle button 211 is on and the PC screen toggle button 212 is on, the panoramic image and the talker images generated by the meeting device 60 and the desktop screen or the screen of the selected application are displayed side by side in the recorded content confirmation window 214.

Thus, an image generated by the information recording application 41 is referred to as a combined video for convenience in the present embodiment although there is a case where the panoramic image and the talker images or the screen of the application is not recorded or a case where none of the panoramic image, the talker image, and the screen of the application are recorded.

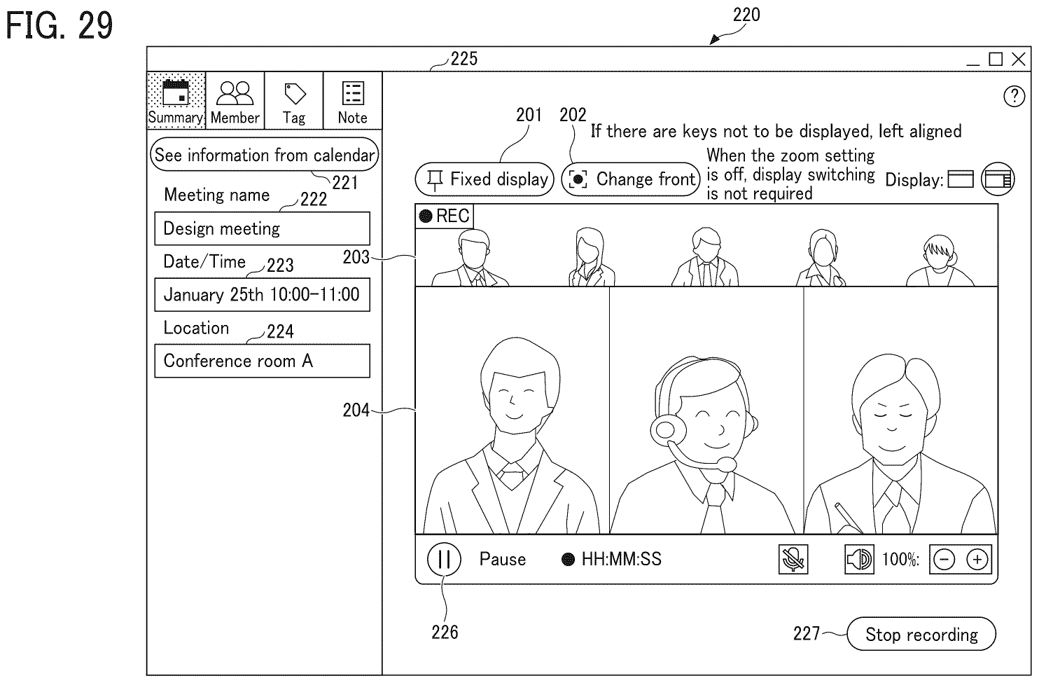

The recording setting screen 210 further includes a check box 215 labelled as “automatically transcribe after uploading the record.” The recording setting screen 210 further includes a button 216 labelled as “start recording now.” If the user checks the check box 215, text data converted from utterances made during the teleconference is attached to the recorded video. In this case, after the end of recording, the information recording application 41 uploads audio data to the information processing system 50 together with a text data conversion request. When the user presses the button 216 labelled as “start recording now,” a recording-in-progress screen 220 is displayed as illustrated in FIG. 29.

FIG. 29 is an example of the recording-in-progress screen 220 displayed by the information recording application 41 during recording. In the description referring to FIGS. 18A-18D, for simplicity, mainly differences from FIG. 27 are described. The recording-in-progress screen 220 displays, in real time, the combined video being recorded according to the conditions set by the user in the recording setting screen 210. The recording-in-progress screen 220 in FIG. 29 corresponds to the case where the camera toggle button 211 is on and the PC screen toggle button 212 is off, and displays the panoramic image 203 and the talker images 204 (both are moving images) generated by the meeting device 60. The recording-in-progress screen 220 includes a recording icon 225, a pause button 226, and a stop recording button 227.

The pause button 226 is a button for pausing the recording. The pause button 226 also receives an operation of resuming the recording after the recording is paused. The stop recording button 227 is a display component (visual representation) for receiving an instruction for ending the recording. The recording ID does not change when the pause button 226 is pressed, whereas the recording ID is changed when the stop recording button 227 is pressed. After pausing or temporarily stopping the recording, the user is allowed to set the recording conditions set in the recording setting screen 210 again before resuming the recording or starting recording again. In this case, the information recording application 41 may generate multiple video files each time the recording is stopped (e.g., when the stop recording button 227 is pressed), or may consecutively combine the plurality of video files to generate a single video (e.g., when the pause button 226 is pressed). When the information recording application 41 plays the combined video, the information recording application 41 may play the plurality of recorded files continuously as one video.

The recording-in-progress screen 220 includes a button 221 labelled as “get information from calendar,” a conference name field 222, a time field 223, and a location field 224. The button 221 labelled as “get information from calendar” allows the user to acquire conference information from the conference management system 9. When the user presses the button 221 labelled as “get information from calendar,” the information recording application 41 acquires a list of conferences for which the user has a viewing authority from the information processing system 50 and displays the acquired list of conferences. The user selects a teleconference to be held from the list of conferences. Consequently, the conference information is reflected in the conference name field 222, the time field 223, and the location field 224. The title, the start time and the end time, and the location included in the conference information are reflected in the conference name field 222, the time field 223, and the location field 224, respectively. The conference information and the record in the conference management system 9 are associated with each other by the conference ID.

In response the user ending the recording after the end of the teleconference, a combined video with sound is generated.

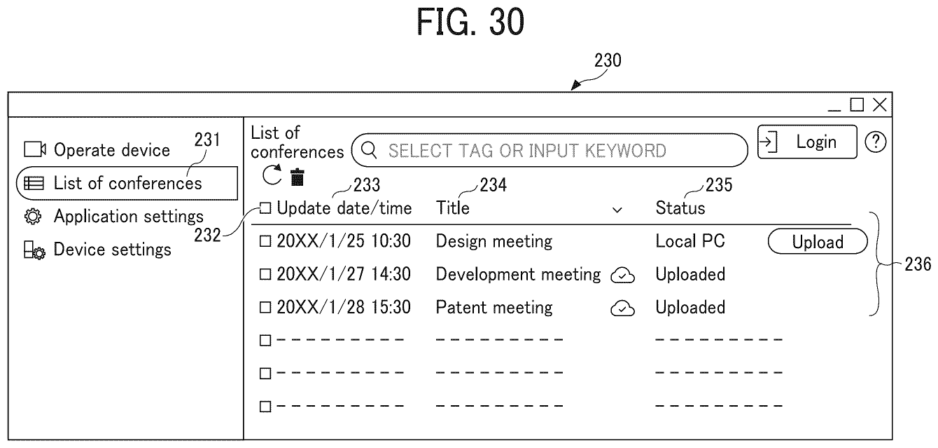

FIG. 30 is an example of a conference list screen 230 displayed by the information recording application 41. The conference list screen 230 presents a list of conferences, specifically, a list of the records (videos) recorded during teleconferences. The list of conferences includes conferences held in a certain conference room as well as teleconferences.

The conference list screen 230 displays conference information for which the logged-in user has a right to view, in the conference information storage area 5001. The information on the video, stored in the information storage area 1001, may be further integrated.

The conference list screen 230 is displayed when the user selects a conference list tab 231 on the initial screen 200 of FIG. 27. The conference list screen 230 displays a list 236 of the videos (records) for which the user has the viewing authority. The conference creator (minutes creator) can set the right to view for a participant of the conference. The list of conferences may be a list of stored records, a list of scheduled conferences, or a list of conference data.

The conference list screen 230 includes items of a check box 232, an update date/time 233, a title 234, and a status 235.

The check box 232 receives selection of a video file. The check box 232 is used when the user desires to collectively delete video files.

The update date/time 233 indicates a recording start time of the combined video. If the combined video is edited, the update date/time 233 may indicate the edited date and time.

The title 234 indicates the title (such as a subject) of the conference. The title may be transcribed from the conference information or set by the user.

The status 235 indicates whether the combined video has been uploaded to the information processing system 50. If the video has not been uploaded, “local PC” is displayed, whereas if the video has been uploaded, “uploaded” is displayed. If the video has not been uploaded, an upload button is displayed. If there is a combined video yet to be uploaded, it is desirable that the information recording application 41 automatically upload the combined video when the user logs into the information processing system 50.

When the user selects a desired title from the list 236 of the combined videos with a pointing device, the information recording application 41 displays a replay screen. The replay screen allows playback of the combined video.

It is desirable that the information recording application 41 provides a function for the user to narrow down conferences based on the update date and time, the title, the keyword, or the like. Further, there may be a situation where the user has difficulty finding a conference of interest because many conferences are displayed. For such a case, the information recording application 41 desirably provides a search function for receiving input of a word or phrase to narrow down the video (record) and to present videos having a title or including an utterance that matches the input word or phrase. The search function allows the user to find desired record in a short time even if the number of records increases. The conference list screen 230 may allow the user to sort the conferences by using the update date and time or the title.

### Recording Operation or Processing

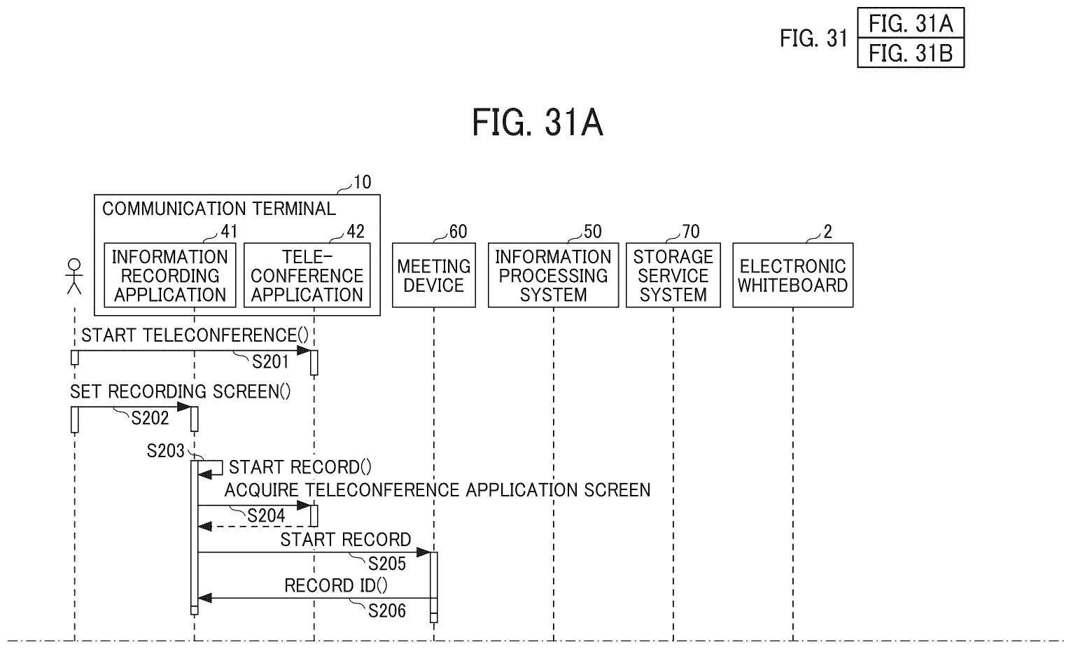

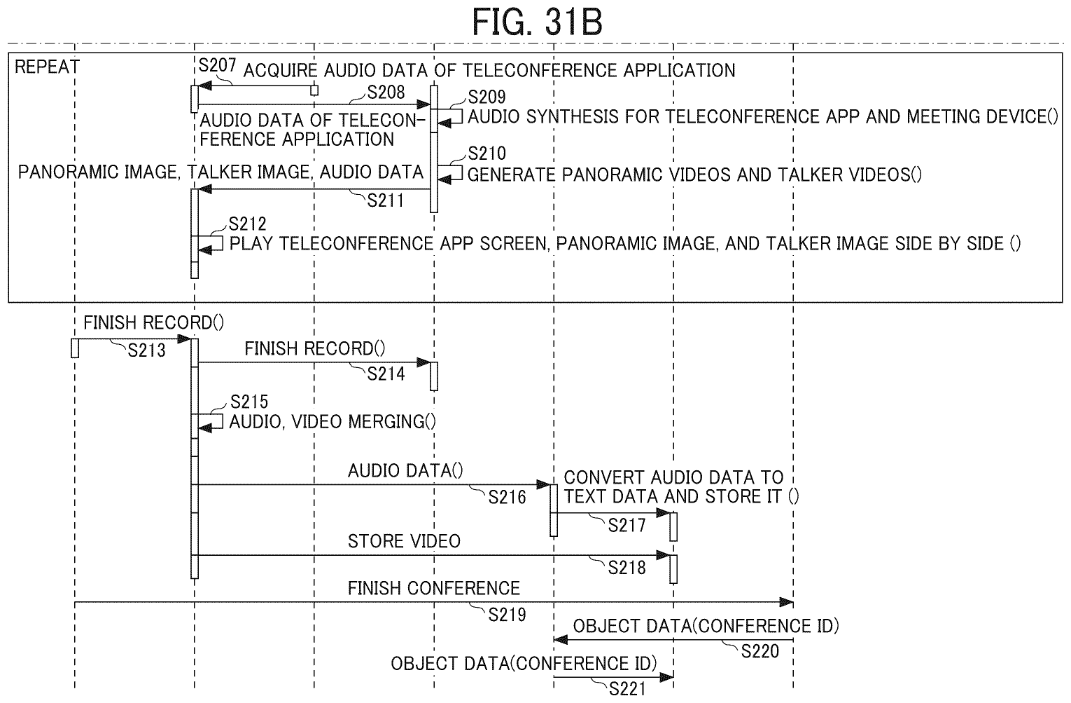

FIGS. 31A and 31B is an example of a sequence diagram showing the procedure for the information recording application 41 to record a panoramic image, a talker image, and the application screen. Conference participation and mute control have already been completed.

S201: The user operates the teleconference app 42 to start a remote conference. Here, it is assumed that the teleconference apps 42 of the first site 102 and the second site 101 have started a teleconference. The teleconference app 42 of the first site 102 transmits an image captured by the camera of the meeting device 60 and an audio collected by the microphone 608 to the teleconference app 42 of the second site 101. The teleconference app 42 of the second site 101 displays the received image on a display and outputs the received audio from the speaker 619. Similarly, the teleconference app 42 of the second site 101 transmits an image captured by the camera of the meeting device 60 and an audio collected by the microphone 608 to the teleconference app 42 of the first site 102. The teleconference app 42 of the first site 102 displays the received image on a display and outputs the received audio from the speaker 619. Each teleconference app 42 repeats this to realize the remote conference.

S202: The user sets the recording settings on the recording setting screen 210 of the information recording application 41 shown in FIG. 28. The operation reception unit 12 of the information recording application 41 accepts the settings. Here, it is assumed that the camera toggle button 211 and the PC screen toggle button 212 are both on.

S203: When the user operates to start recording, the recording control unit 17 of the information recording application 41 starts recording.

S204: The app screen acquisition unit 14 of the information recording application 41 requests the application screen selected by the user (more specifically, the app screen acquisition unit 14 acquires the application screen via the OS). In FIGS. 31A and 31B, the application selected by the user is the teleconference application 42.

S205: The recording control unit 17 of the information recording application 41 notifies the meeting device 60 of the start of recording via the device communication unit 16. When notifying, the recording control unit 17 should also notify that the camera toggle button 211 is on (request for a panoramic image and a talker image). Regardless of whether a request is made, the meeting device 60 sends the panoramic image and the talker image to the information recording application 41.

S206: When the terminal communication unit 61 of the meeting device 60 receives a recording start signal, it assigns a unique recording ID and returns the recording ID to the information recording application 41. The recording ID may be assigned by the information recording application 41 or may be obtained from the information processing system 50.

S207: The audio reception unit 15 of the information recording application 41 acquires the audio data output by the terminal device 10 (audio data received by the teleconference application 42).

S208: The device communication unit 16 transmits the audio data acquired by the audio reception unit 15 and a synthesis request to the meeting device 60.

S209: The terminal communication unit 61 of the meeting device 60 receives the audio data and the synthesis request, and the audio synthesis unit 65 synthesizes the surrounding audio data collected by the sound collection unit 64 with the received audio data. For example, the audio synthesis unit 65 adds the two pieces of audio data together. Since clear audio around the meeting device 60 is recorded, the accuracy of converting audio around the meeting device 60 (conference room side) into text is improved.

This audio synthesis can also be performed by the terminal device 10. The recording function may be distributed to the meeting device 60, and the audio processing may be distributed to the terminal device 10. In this case, the load on the meeting device 60 is reduced.

S210: The panoramic image generation unit 62 of the meeting device 60 generates a panoramic image, and the talker image generation unit 63 generates a talker image.

S211: The device communication unit 16 of the information recording application 41 repeatedly acquires the panoramic image and the talker image from the meeting device 60. The device communication unit 16 also repeatedly acquires the synthesized audio data from the meeting device 60. These acquisitions may be performed by the device communication unit 16 making a request to the meeting device 60. Alternatively, the meeting device 60 that has received a notice that the camera toggle button 211 is on may automatically transmit the panoramic image and the talker image. The meeting device 60 that has received a request to synthesize audio data may automatically transmit the synthesized audio data to the information recording application 41.

S212: The recording control unit 17 of the information recording application 41 generates a combined image by arranging the app screen obtained from the teleconference application 42, the panoramic image, and the talker image side by side. The recording control unit 17 repeatedly generates combined images and generates a combined image video by specifying each combined image as a frame that makes up the video. The recording control unit 17 also stores the audio data received from the meeting device 60.

The information recording application 41 repeats the above steps S207 to S212.

S213: When the teleconference ends and recording is no longer necessary, the user instructs the information recording application 41 to end recording (for example, by pressing the recording end button 227). The operation reception unit 12 of the information recording application 41 receives the instruction.

S214: The device communication unit 16 of the information recording application 41 notifies the meeting device 60 that recording has ended. The meeting device 60 continues generating panoramic images and talker images and synthesizing audio. However, the meeting device 60 may change the processing load, such as changing the resolution or fps, depending on whether recording is in progress.

S215: The recording control unit 17 of the information recording application 41 combines the audio data with the combined image moving image to generate a combined image moving image with audio.

S216: Furthermore, if the user checks the check box 215 associated with “Automatically transcribe recording after uploading” on the recording setting screen 210, the audio data processing unit 18 requests the information processing system 50 to convert the audio data into text data. In detail, the audio data processing unit 18 specifies the URL of the save destination via the communication unit 11, and sends a conversion request for the audio data combined with the combined image video to the information processing system 50 together with the conference ID and recording ID.

S217: The communication unit 51 of the information processing system 50 receives a request to convert the audio data, and the text conversion unit 56 converts the audio data into text data using the speech recognition service system 80. The communication unit 51 stores the text data in the same storage destination (URL of the storage service system 70) as the storage destination of the combined image video. In the record information storage area 5002, the text data is associated with the combined image video by the conference ID and the recording ID. The text data may be managed by the communication management unit 54 of the information processing system 50 and stored in the storage unit 5000. In addition, the terminal device 10 may request audio recognition from the speech recognition service system 80 and store the text data acquired from the speech recognition service system 80 in the storage destination. In addition, the speech recognition service system 80 returns the converted text data to the information processing system 50, but may also directly send it to the URL of the storage destination. The speech recognition service system 80 may select or switch between multiple services depending on the setting information set by the user in the information processing system 50.

S218: Furthermore, the upload unit 20 of the information recording application 41 stores the combined image video in the storage destination for the combined image video via the communication unit 11. In the record information storage area 5002, the combined image video is associated with the conference ID and the recording ID. “Uploaded” is recorded in the combined image video.

S219: The user inputs the end of the conference into the electronic whiteboard 2. The user may input the end of the meeting into the terminal device 10, and the end of the conference may be transmitted from the terminal device 10 to the electronic whiteboard 2. In this case, the end of the meeting may be transmitted to the electronic whiteboard 2 via the information processing system 50.

S220: The communication unit 35 of the electronic whiteboard 2 specifies the conference ID and transmits object data displayed (e.g., handwritten) during the conference to the information processing system 50. The communication unit 35 may also transmit device identification information of the electronic whiteboard 2 to the information processing system 50. In this case, the conference ID is identified by the association information.

S221: The information processing system 50 stores the object data in the same storage location as the combined image movie and the like based on the conference ID.

The user is notified of the save destination, and can share the combined image video with participants by informing them of the save destination by email or other means. Even if the combined image video, audio data, text data, and object data are generated using different devices, they can all be collected and stored in a single storage location and can be easily viewed by users etc. later.

The processing of steps S207 to S212 does not have to be performed in the order shown in FIGS. 31A and 31B, and the synthesis of the audio data and the generation of the combined image may be performed in the opposite order.

### Main Effect

The image processing system 91 of this embodiment calculates the scale ratio of each image and notifies the teleconference service system 90, even if the subject size in the image sent by each base is different, so that the terminal device 10 can display each image with the subject size being approximately the same.

While the present disclosure has been described above using various embodiments, the embodiments do not limit the present disclosure in any way. Various modifications and replacements may be made within a scope not departing from the gist of the present disclosure. For example, elements and/or features of different illustrative embodiments may be combined with each other and/or substituted for each other within the scope of the present invention. Any one of the above-described operations may be performed in various other ways, for example, in an order different from the one described above.

For example, the arrangement of panoramic images 301, 302, and image 303 on the conference screen 330 used in this embodiment is merely an example. Image 303 may be arranged on the left side, or panoramic images 301 and 302 may be arranged side by side.

Furthermore, although a face has been given as an example of a subject, the subject may be a part of the body, such as a hand, in addition to the face. The subject may also be any display or device, such as an electronic whiteboard.

The functional elements of the configuration illustrated in, for example, FIG. 10 are divided according to main functions in order to facilitate understanding of processing executed by the communication terminal 10, the meeting device 60, and the information processing system 50. No limitation is intended by how the functions are divided by processes or by the name of the functions. The processes performed by the communication terminal 10, the meeting device 60, and the information processing system 50 may be divided into a greater number of processing units, functions, or steps in accordance with the content of the processing. In addition, a single processing unit can be further divided into a plurality of processing units.

The apparatuses or devices described in one embodiment are just one example of multiple computing environments that implement the one embodiment in this specification. In some embodiments, the information processing system 50 includes multiple computing devices, such as a server cluster. The plural computing devices communicate with one another through any type of communication link including a network, shared memory, etc., and perform the processes disclosed herein.

The information processing system 50 may share the processing steps disclosed herein, for example, steps in FIG. 20 or the like in various combinations. For example, a process performed by a predetermined unit may be performed by a plurality of information processing apparatuses included in the information processing system 50. Further, the elements of the information processing system 50 may be combined into one server apparatus or are allocated to multiple apparatuses.

Each of the functions or units of the above-described embodiments may be implemented by one or more pieces of processing circuitry or circuitry. The term “processing circuit or circuitry” used herein refers to a processor that is programmed to carry out each function by software such as a processor implemented by an electronic circuit, or a device such as an application specific integrated circuit (ASIC), digital signal processor (DSP), field programmable gate array (FPGA), or existing circuit module that is designed to carry out each function described above.

Processors are considered processing circuitry or circuitry as they include transistors and other circuitry therein. In the disclosure, the circuitry, units, or means are hardware that carries out or are programmed to perform the recited functionality. The hardware may be any hardware disclosed herein which is programmed or configured to carry out the recited functionality. When the hardware is a processor which may be considered a type of circuitry, the circuitry, means, or units are a combination of hardware and software, the software being used to configure the hardware and/or processor.

1. A non-transitory recording medium storing program code which, when executed by one or more processors, causes the one or more processors to perform a method comprising:
calculating a scale ratio of images transmitted from sites so that a subject size in each image is approximately the same;
scaling each image using the scale ratio which was calculated; and
displaying each image that has been scaled at the scale ratio at a terminal.

2. The non-transitory recording medium of claim 1, wherein the method further comprises:
determining layout coordinates when the images are enlarged or reduced at the scale ratio which was calculated and arranged on a conference screen displayed by the terminal,
wherein the displaying includes displaying each image at the scale ratio and at the layout coordinates on the conference screen at the terminal.

3. The non-transitory recording medium of claim 1, wherein the method further comprises:
obtaining the subject size by detecting a predetermined subject in one image transmitted from each site, or obtaining the subject size from a teleconference service system;
calculating an average subject size of multiple subjects in one image sent from each site; and
calculating an overall average size, which is an average of the average subject sizes for each site,
wherein the calculating the scale ratio calculates the scale ratio which when applied to the average subject size results in the overall average size.

4. The non-transitory recording medium of claim 3, wherein the method further comprises:
excluding from the calculation of the average subject size images which have a size below a predetermined threshold.

5. The non-transitory recording medium of claim 2, wherein the method further comprises:
arranging each of the images enlarged or reduced by the scale ratio vertically or horizontally from an edge of the conference screen, and
reducing each of the images to fit within a height or width of the conference screen, in a case that a fixed number of images cannot be arranged in the height or width of the conference screen.

6. The non-transitory recording medium of claim 3, wherein the method further comprises:
calculating an average subject size of multiple subject sizes appearing in one image transmitted from each site, and
calculating the ratio of the average subject size to the average size inputted on the terminal as the scale ratio.

7. The non-transitory recording medium of claim 1, wherein the method further comprises:
requesting the teleconference service system to trim a circumscribed rectangle of a predetermined subject from each of the images which is enlarged or reduced, in a case that a notification is received that a conference screen is in a material display mode;
enlarging or reducing each of the images at the scale ratio; and
transmitting the circumscribed rectangle of the predetermined subject trimmed from each of the images to the terminal at each site.

8. The non-transitory recording medium of claim 1, wherein:
the subject size is a face size of participants in the conference.

9. An image processing system for communicating with a teleconference service system that transmits an image transmitted from one site to another site comprising:
circuitry configured to:
calculate a scale ratio of images transmitted from the sites so that a subject size in each image is approximately the same;
scale each image using the scale ratio which was calculated; and
display, at the sites, each image that has been scaled at the scale ratio.

10. The image processing system of claim 9, wherein the circuitry is further configured to:
determine layout coordinates when the images are enlarged or reduced at the scale ratio which was calculated and arranged on a conference screen displayed by a terminal at each site,
wherein the circuitry is configured to perform the display such that each image is displayed at the scale ratio and at the layout coordinates on the conference screen at the terminal.

11. The image processing system of claim 9, wherein the circuitry is further configured to:
obtain the subject size by detecting a predetermined subject in one image transmitted from each site, or obtaining the subject size from a teleconference service system;
calculate an average subject size of multiple subjects in one image sent from each site; and
calculate an overall average size, which is an average of the average subject sizes for each site,
wherein the calculating the scale ratio calculates the scale ratio which when applied to the average subject size results in the overall average size.

12. The image processing system of claim 11, wherein the circuitry is further configured to:
exclude from the calculation of the average subject size images which have a size below a predetermined threshold.

13. The image processing system of claim 10, wherein the circuitry is further configured to:
arrange each of the images enlarged or reduced by the scale ratio vertically or horizontally from an edge of the conference screen, and
reduce each of the images to fit within a height or width of the conference screen, in a case that a fixed number of images cannot be arranged in the height or width of the conference screen.

14. The image processing system of claim 11, wherein the circuitry is further configured to:
calculate an average subject size of multiple subject sizes appearing in one image transmitted from each site, and
calculate the ratio of the average subject size to an average size inputted on the terminal as the scale ratio.

15. The image processing system of claim 9, wherein the circuitry is further configured to:
request the teleconference service system to trim a circumscribed rectangle of a predetermined subject from each of the images which is enlarged or reduced, in a case that a notification is received that a conference screen is in a material display mode;
enlarge or reducing each of the images at the scale ratio; and
transmit the circumscribed rectangle of the predetermined subject trimmed from each of the images to the terminal at each site.

16. The image processing system of claim 9, wherein:
the subject size is a face size of participants in the conference.

17. A teleconference service system for transmitting an image transmitted from one site to another site,
circuitry configured to:
calculate a scale ratio of each image transmitted from each site so that a subject size in each image is approximately the same;
scale each image using the scale ratio which was calculated; and
display each image that has been scaled by the teleconference service system at the scale ratio at a terminal device.

18. The teleconference service system of claim 17, wherein the circuitry is further configured to:
determine layout coordinates when the images are enlarged or reduced at the scale ratio which was calculated and arranged on a conference screen displayed by the terminal,
wherein the circuitry is configured to perform the display such that each image is displayed at the scale ratio and at the layout coordinates on the conference screen at the terminal.

19. The teleconference service system of claim 17, wherein the circuitry is further configured to:
obtain the subject size by detecting a predetermined subject in one image transmitted from each site, or obtaining the subject size from a teleconference service system;
calculate an average subject size of multiple subjects in one image sent from each site; and
calculate an overall average size, which is an average of the average subject sizes for each site,
wherein the calculating the scale ratio calculates the scale ratio which when applied to the average subject size results in the overall average size.

20. The teleconference service system of claim 19, wherein the circuitry is further configured to:
exclude from the calculation of the average subject size images which have a size below a predetermined threshold.
